(19) United States
(12) Patent Application Publication
(10) Pub. No.: US 2023/0389754 A1
(43) Pub. Date: Dec. 7, 2023

(54) MODULAR SYSTEM FOR FOOD ASSEMBLY

(71) Applicant: Hyphen Technologies, Inc., San Jose, CA (US)

(72) Inventors: Ben Lerner, El Cerrito, CA (US); Bradley Hwang, Aptos, CA (US); Daniel Fukuba, San Jose, CA (US); Stephen Klein, San Jose, CA (US)

(21) Appl. No.: 18/205,235

(22) Filed: Jun. 2, 2023

Related U.S. Application Data
(60) Provisional application No. 63/348,404, filed on Jun. 2, 2022.
(60) Provisional application No. 63/438,721, filed on Jan. 12, 2023.

(51) Int. Cl. A47J 44/00; A47J 47/01

(52) U.S. Cl. CPC A47J 44/00; A47J 47/01

(57) ABSTRACT

One variation a food production system includes: a food preparation surface; a module housing; and a controller. The food preparation surface is located on top of the module housing and defines a receptable configured to receive a food hopper configured to store ingredients for preparation of units of the food product type. The module housing includes: a first food dispensing module configured to dispense a first ingredient; and a second food dispensing module configured to dispense a second ingredient. The module housing further includes a conveyor module to support the rim of a food container beneath the first and second food dispensing modules and transport the food container. The controller can receive a food order; trigger the conveyor module to advance by a distance; and trigger the food dispensing modules to dispense ingredients into the food container.

### CROSS-REFERENCE TO RELATED APPLICATIONS

This application claims the benefit of U.S. Provisional Application No. 63/348,404, filed on 2 Jun. 2022, and 63/438,721, filed on 12 Jan. 2023, each of which is incorporated in its entirety by this reference.

This application is related to U.S. patent application Ser. No. 17/494,736, filed on 5 Oct. 2021, which is incorporated in its entirety by this reference.

### TECHNICAL FIELD

This invention relates generally to the field of food production and more specifically to a new and useful modular system for manual and autonomous food assembly in the field of food production.

### BRIEF DESCRIPTION OF THE FIGURES

FIG. 1 is a schematic representation of a food production system;

FIGS. 2A and 2B are schematic representations of one variation of the food production system;

FIG. 3 is a schematic representation of one variation of the food production system;

FIG. 4 is a schematic representation of one variation of a conveyor module of the food production system;

FIG. 5 is schematic representations of one variation of a conveyor module of the food production system;

FIG. 6 is a schematic representation of one variation of the food production system;

FIG. 7 is a schematic representation of one variation of a food dispensing module of the food production system;

FIG. 8 is a schematic representation of one variation of the food production system;

FIG. 9 is a schematic representation of one variation of the food production system; and

FIG. 10 is a schematic representation of one variation of the food production system.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Food Production System

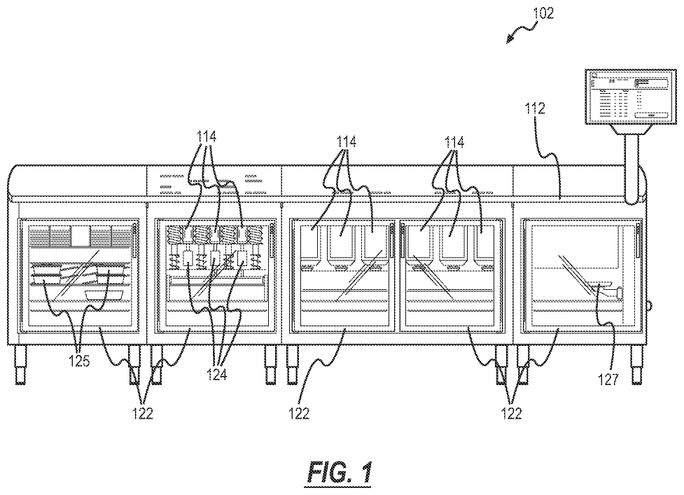

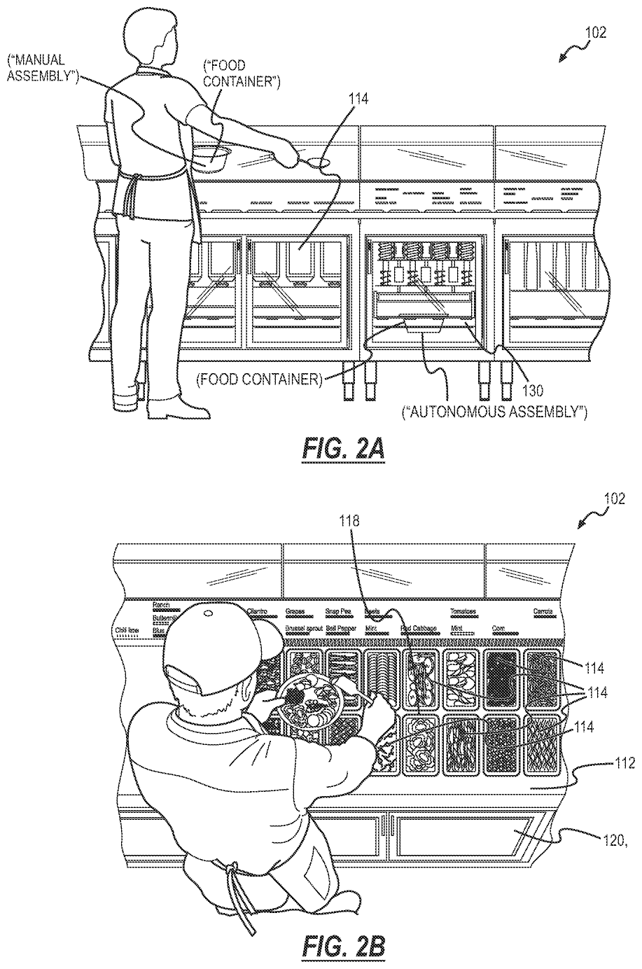

As shown in FIGS. 1, 2A and 2B, a food production system 102 for assembling units of a food product type includes: a first module housing 122 and a controller.

The first module housing 122 defines an autonomous assembly zone 120 extending along a longitudinal assembly axis 140. The first module housing 122 is configured to: transiently house a first food dispensing module 124 configured to dispense a first ingredient toward the autonomous assembly zone 120; and transiently house a second food dispensing module 124 located adjacent the first food dispensing module 124 configured to dispense a second ingredient toward the autonomous assembly zone 120. The first module housing 122 further includes a first conveyor module 130 arranged within the autonomous assembly zone 120 of the first module housing 122. The first conveyor module 130 includes: a first conveyor belt 132 extending parallel to and laterally offset behind the longitudinal assembly axis 14o; and a second conveyor belt 134 extending parallel to and laterally offset in front of the longitudinal assembly axis 140 configured to cooperate with the first conveyor belt 132 to support a rim of a food container 115 with a base of the food container 115 extending below the first conveyor belt 132 and the second conveyor belt 134.

The controller is configured to: receive a food order indicating a first ingredient and a second ingredient; locate a first region of the food container 115 beneath the first food dispensing module 124 by triggering the first conveyor belt 132 and the second conveyor belt 134 to advance by a first distance 142; trigger the first food dispensing module 124 to dispense the first ingredient into the first region of the food container 115; locate a second region of the food container 115 beneath the second food dispensing module 124; and trigger the second food dispensing module 124 to dispense the second ingredient into the second region of the food container 115.

The controller locates the second region of the food container 115 beneath the second food dispensing module 124 by: triggering the first conveyor belt 132 to advance by a second distance 144; and triggering the second conveyor belt 134 to advance by a third distance 146.

### 1.1 Food Production System Variation

In one variation the food production system 102 further includes a food preparation surface for an operator of the system to manually assemble a unit of the food product type. In this variation, the food production system 102 includes a food preparation surface, first module housing 122, and a controller. The food preparation surface is located above the first module housing 122 at a work surface height and defines a receptable configured to receive a food hopper 114 configured to store ingredients for preparation of units of the food product type.

The first module housing 122 defines an autonomous assembly zone 120 extending along a longitudinal assembly axis 140. The first module housing 122 is configured to: transiently house a first food dispensing module 124 configured to dispense a first ingredient toward the autonomous assembly zone 120; and transiently house a second food dispensing module 124 located adjacent the first food dispensing module 124 and configured to dispense a second ingredient toward the autonomous assembly zone 120. The first module housing 122 further includes a first conveyor module 130 arranged within the autonomous assembly zone 120 of the first module housing 122. The first conveyor module 130 includes: a first conveyor belt 132 extending parallel to and laterally offset behind the longitudinal assembly axis 14o; and a second conveyor belt 134 extending parallel to and laterally offset in front of the longitudinal assembly axis 140 configured to cooperate with the first conveyor belt 132 to support a rim of a food container 115 with a base of the food container 115 extending below the first conveyor belt 132 and the second conveyor belt 134.

The controller is configured to: receive a food order indicating a first ingredient and a second ingredient; locate a first region of the food container 115 beneath the first food dispensing module 124 by triggering the first conveyor belt 132 and the second conveyor belt 134 to advance by a first distance 142; trigger the first food dispensing module 124 to dispense the first ingredient into the first region of the food container 115; locate a second region of the food container 115 beneath the second food dispensing module 124; and trigger the second food dispensing module 124 to dispense the second ingredient into the second region of the food container 115.

The controller locates the second region of the food container 115 beneath the second food dispensing module 124 by: triggering the first conveyor belt 132 to advance by a second distance 144; and triggering the second conveyor belt 134 to advance by a third distance 146.

### 2. Method

The controller of the food production system 102 executes a method S100 for the food production system 102 to assemble a unit of the food product type. The method S100 includes: receiving a food order indicating a set of ingredients to be dispensed into a set of regions of a food container 115 including the unit of the food product type—in Block S110. Further, in response to the food order specifying a first ingredient in a first region of the food container 115: locating the first region of the food container 115 beneath a first food dispensing module 124 of the first module housing 122—in Block S120; and triggering the first food dispensing module 124 to dispense a first ingredient in the set of ingredients into the first region of the food container 115—in Block S130.

The controller locates the first region of the food container 115 beneath a first food dispensing module 124 of the first module housing 122 by: triggering a first conveyor belt 132 of the conveyor module 130 of the first module housing 122 to advance by a first distance 142; and triggering a second conveyor belt 134 of the conveyor module 130 of the first module housing 122 to advance by the first distance 142—in Block S120.

The method S100 further includes: in response to the food order specifying a second ingredient in a second region of the food container 115: locating the second region of the food container 115 beneath a second food dispensing module 124 of the first module housing 122—in Block S140; and triggering the second food dispensing module 124 to dispense a second ingredient in the set of ingredients into the second region of the food container 115—in Block S150.

The controller locates the second region of the food container 115 beneath a second food dispensing module 124 of the first module housing 122 by: triggering the first conveyor belt 132 of the conveyor module 130 of the first module housing 122 to advance by a second distance 144; and triggering the second conveyor belt 134 of the conveyor module 130 of the first module housing 122 to advance by a third distance 146—in Block S140.

### 3. Applications

Generally, the food production system 102 defines a reconfigurable chassis for on-demand food production and includes: a food preparation surface supporting manual construction of units of a food product by a worker (e.g., an employee); a module housing 122 supporting the food preparation surface and defining an autonomous assembly zone 120; and a controller.

The module housing 122 supports the food preparation surface and defines an autonomous assembly zone 120 including a sequence of food dispensing modules 124 configured to transiently (i.e., temporarily and removably) install in the food production system 102, configured to store ingredients, and configured to dispense volumes or units of these ingredients to autonomously construct units of a food product. For example, the autonomous assembly zone 120 can be configured to autonomously assemble generic units of the same food type that is concurrently assembled and customized manually by a worker at the food preparation surface above.

Furthermore, the food production system 102 can be assembled and reconfigured over time to produce various types of food products, such as smoothies, cold bowls (e.g., cold salads), hot bowls (e.g., hot rice bowls), cold sandwiches, hot sandwiches, cold wraps, hot wraps (e.g., burritos), desserts, coffee products, etc.

The food production system 102 can be configured for installation in a food service establishment to augment manual food product assembly with autonomous food product assembly, such as to fulfill orders entered by on-site patrons and/or submitted online via remote patrons. Furthermore, multiple instances of the food production system 102 can be located within the food service establishment in order to increase food order throughput. For example, a “fast-casual” restaurant may install a first instance of the food production system 102 outside and adjacent a kitchen of the restaurant, such that patrons may assemble in a line passing by a customer-facing side of the first instance of the food production system 102. This restaurant may also install a second and third instance of the food production system 102 within the kitchen of the restaurant (e.g., out of sight of patrons) to increase food order throughput (e.g., by doubling a food order capacity of the restaurant). For example, two food production systems 102 can be stacked, thus disabling the manual assembly zone of these two food production systems 102 and enabling the two autonomous assembly zone 120S in these two food production systems 102, which may yield greater maximum throughout per unit floor area at the restaurant. Therefore, in this stacked configuration, the second and third instances of the food production system 102 can each receive food orders and can autonomously prepare multiple food orders simultaneously within their respective autonomous assembly zone 120S. A computer system can also selectively distribute food orders received from patrons between these three instances of the food production system 102 and communicate instructions for accurate and timely completion of these food orders.

The conveyor module 130 of the food production system 102 includes a first and second conveyor belt 134, each configured to: support the rim of a food container 115 (e.g., a “bowl”); and translate and rotate the food container 115 under multiple food dispensing modules 124 within the food production system 102. In particular, the controller—within the food production system 102—can execute commands to operate the first and second conveyor belt at dissimilar speeds, distances, and directions in order to: rotate the food container 115 (e.g., 45 degrees, 90 degrees, 180 degrees) over a range of positions along the food production system 102; locate a target region of the food container 115 under a food dispensing module 124 within the food production system 102; trigger the food dispensing module 124 to dispense an ingredient (e.g., hot ingredients, cold ingredients, dry ingredients) into the food container 115 at the target region; and locate the food container 115 under a second food dispensing module 124 to receive a second ingredient. Therefore, the food production system 102 is configured to achieve a target ingredient plating (e.g., visually appealing, visually balanced, and/or physically balanced) within the food container 115, and thus achieve high food container 115 through-put and accurate and repeatable plating of custom combinations of ingredients.

Furthermore, the conveyor module 130 is configured to support a rim of the food container 115 while navigating the food container 115 through the autonomous assembly zone 120. By supporting the rim of the food container 115, rather than the base or bottom of the food container 115, the conveyor module 130 can accept food containers 115 of different depths and volumes (e.g., 8 oz, 16 oz, and 24 oz bowls) and maintain the top of each size of the food containers 115 within a target distance (e.g., within 3 inches) of the outputs of a food dispensing module 124. The conveyor module 130 thereby limits incidence dispensed ingredients missing or falling out of the food container 115. Furthermore, by interfacing with a food container 115 at its widest point (i.e., its rim), the conveyor module 130 can achieve a greatest positional accuracy and ingredient position resolution within the food container 115.

Generally, the food container 115 may be susceptible to tipping if ingredients within the food container 115 are imbalanced. Therefore, the controller can execute commands to implement methods described below to selectively navigate the food container 115 between food dispensing modules 124—based on weights and quantities of ingredients specified in a corresponding food order—in order to: maintain weight balance along the lateral axis of the food container 115; prevent the food container 115 from tipping on the conveyor module 130; and achieve consistent (e.g., repeatable, predictable) steering (e.g., skid-steering) of the food container 115 on the conveyor module 130 as the food production system 102 loads ingredients into the food container 115.

The food production system 102 can additionally translate and rotate food containers 115 beneath and between food dispensing modules 124 in order to arrange ingredients in a target layout within the food container 115. The controller can actuate the conveyor module 130 based on a plating instruction associated with a food item ordered from the food production system 102. The food production system 102 thereby achieves a visually pleasing and weight-balanced plating of ingredients within the food container 115.

Furthermore, the controller can calculate target locations of ingredients and food dispensing modules 124 within the food production system 102—such as based on historical order frequency and known ingredient serving weights—predicted: to yield greatest central weight balance in the center of the food container 115 and/or to yield greatest lateral weight balance parallel to the direction of motion of the conveyor module 130 at any time as the food production system 102 loads ingredients into the food container 115; to enable concurrent ingredient dispensation of similar weights into the food container 115 from food dispensing modules 124 on opposing sides of the longitudinal assembly axis 140 of the conveyor module 130; to reduce translational and/or rotational operations needed to load all ingredients into the food container 115 according to a corresponding food order; and to fulfill predefined plating rules (e.g., lettuce or rice followed by toppings, then sauce, then condiments).

### 4. Food Production System Components

The food production system 102 can be configured to install within a food service establishment (e.g., a “fast-casual” restaurant, a ghost kitchen, a food court, a cafeteria) and can be assembled and reconfigured over time to produce various types of food product, such as smoothies, cold bowls (e.g., cold salads), hot bowls (e.g., hot rice bowls), cold sandwiches, hot sandwiches, cold wraps, hot wraps (e.g., burritos), pizzas, desserts, coffee products, etc.

Once a combination of food dispensing modules 124 is assembled onto the food production system 102 to construct a particular type of food product, the food production system 102 can be loaded with a control program configured to: intake food orders from patrons; and to selectively actuate the food dispensing modules 124 to construct instances of this food product according to these food orders.

The food production system 102 defines a base platform or “chassis” configured to support and locate a combination of food dispensing modules 124 for fulfillment of food orders. In one implementation, the food production system 102 includes: a chassis (e.g., a rigid platform) defining a food preparation surface; and a module housing 122—including a sequence of module housings 122—arranged beneath the food preparation surface and configured to house a sequence of food dispensing modules 124 for fulfillment of food orders; and a sequence of food containers 115 (or “food hopper”)—transiently arranged within the sequence of module housings 122—configured to store ingredients for manual preparation of a food product type on the food preparation surface. For example, the food production system 102 can include: a steel box frame configured to support a sequence of food hopper and food dispensing modules 124; a food preparation surface (e.g., a stainless steel surface) arranged over a top face of the steel box frame; and a set of legs (e.g., a set of round tubular legs) coupled to a bottom face opposite the top face of the steel box frame and configured to support the steel box frame.

The food production system 102 can include a sequence of food hopper arranged along a rear of the food preparation surface (e.g., opposite an employee working at the food production system 102) such that these food hopper are arranged contiguously along a length of the food preparation surface and ordered accordingly to efficiently and satisfactorily complete food orders. The food production system 102 can also include a module housing 122: located beneath the food preparation surface and within the steel box frame; including a sequence of module housings 122 configured to transiently house a sequence of food dispensing modules 124 configured to selectively dispense food ingredients according to food orders received by the food production system 102.

The food production system 102 can define a particular height (e.g., a work height) such that an employee may comfortably stand facing a front side of the food production system 102 while handling food (e.g., adding ingredients to a serving container, preparing ingredients, refilling food hopper) on the food preparation surface and/or interfacing with a patron. For example, the food production system 102 can exhibit a height—between a ground surface and the food preparation surface—approximately (e.g., within two inches) between 35 inches and 42 inches. Furthermore, the bottom surface of the food production system 102 can be offset a ground surface (e.g., the floor) in order to enable cleaning beneath the food production system 102. For example, the food production system 102 can include the set of legs defining a particular height such that: an employee may clean the bottom surface of the food production system 102 and surfaces (e.g., the floor) below the food production system 102; the food preparation surface sits within a working height range (e.g., between 36 and 38 inches); and the module housing 122, including a sequence of food dispensing modules 124, fits between the bottom surface and the food preparation surface.

### 4.1 Manual Assembly Zone

The food production system 102 can include a manual assembly zone 110 including the food preparation surface and a receptacle configured to receive the sequence of food hopper transiently located atop the food preparation surface and configured to store ingredients for manual preparation of units of food products according to food orders submitted by patrons. As shown in FIGS. 2A and 2B, the manual assembly zone 110 can be configured such that an employee may stand facing a front side of the food production system 102—proximal the sequence of food hopper—to handle ingredients and/or assemble food orders while a patron views and/or manually points at ingredients along a rear of the food production system 102.

### 4.2 Autonomous Assembly Zone

The food production system 102 can include an autonomous assembly zone 120 located below the food preparation surface of the manual assembly zone 110. The autonomous assembly zone 120 includes: a sequence of module housings 122 configured to house a set of food-handling modules (e.g., food dispensing modules 124, food processing modules); a conveyor module 130 configured to move a food container 115 along a length of the autonomous assembly zone 120 as the food container 115 is filled with ingredients; and a controller configured to receive food orders from patrons and selectively actuate the set of food-handling modules for dispensation of ingredients in order to complete these food orders. The autonomous assembly zone 120 can include a sequence of food hopper configured to store ingredients corresponding to food orders. In one implementation, as described above, the sequence of food hopper located along the manual assembly zone 110 are coupled to the set of food-handling modules of the autonomous assembly zone 120, such that the sequence of food hopper can be configured to store ingredients for both the manual assembly zone 110 and the autonomous assembly zone 120.

### 4.3 Module Housings

The module housing 122 defines the autonomous assembly zone 120 and transiently houses components for autonomous assembly of units of a food product type. The food production system 102 can include a set of module housings 122 arranged in a sequence. Each module housing 122 can include a set of ingredients dispensed by a food dispensing module 124 or a set of food dispensing modules 124. The module housing 122 is configured to transiently house a first food dispensing module 124 configured to dispense a first ingredient into the food container 115. In one implementation, the module housing 122 can include a set of food dispensing modules 124 to dispense multiple ingredients.

Each module housing 122 can include an inlet door and an output door to interface with adjacent module housings 122. For example, a first module housing 122, a second module housing 122, and a third module housing 122 can be arranged in sequence. The first module housing 122 can include a container dispensing module 125 configured to output a food container 115 and a first conveyor module 130 configured to transfer the food container 115 to the second module housing 122. The controller advances the conveyor belts of the first conveyor module 130 to transfer the container to a first output door of the first module housing 122. The first output door of the first module housing 122 is arranged facing and abutting a second inlet door of the second module housing 122 adjacent to the first module housing 122. The second inlet door is arranged on the second module housing 122 facing the container dispensing module 125 of the first module housing 122. The first conveyor module 130 transfers the food container 115 into the first output door and the second conveyor module 130 transfers the food container 115 into the second inlet door and into the second module housing 122. The second conveyor module 130: is interposed between the second inlet door and the second output door of the second module housing 122; and can transfer the food container 115 within the second module housing 122 to locate the food container 115 beneath a food dispensing module 124 of the second module housing 122 to dispense an ingredient. The second conveyor module 130 can then transfer the food container 115 to a second output door of the second module housing 122 and a third conveyor module 130 of an adjacent third module housing 122 can transfer the food container 115 into the third module housing 122 through the third inlet door.

The components within each module housing 122 of the food production system 102 are arranged along a longitudinal assembly axis 140 on which the unit of the food product type is assembled. For example, the conveyor belt can be arranged on the longitudinal assembly axis 140 to transport food along the longitudinal assembly axis 140. The food dispensing modules 124 can additionally be positioned along the longitudinal assembly axis 140 above the conveyor module 130 to dispense ingredients into the food container 115.

### 4.4 Conveyor Module

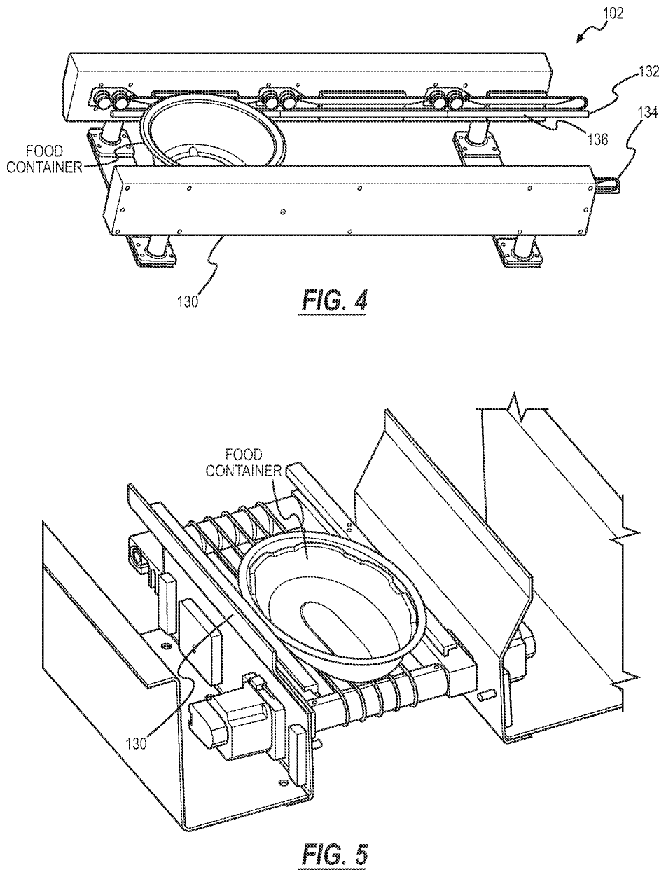

Generally, a conveyor module 130 includes a pair of (e.g., two) conveyor belts laterally offset and mirrored across a longitudinal axis (e.g., the longitudinal assembly axis 140) of the food production system 102. The pair of conveyor belts cooperate to support short, opposing segments (e.g., arcs of a round food container 115) of a rim of a food container 115. The conveyor module 130 further includes a set of rub rails 136: laterally offset and mirrored across the longitudinal axis of the food production system 102; arranged within a set of guides and below the first and second conveyor belt; configured to support segments of the base of a food container 115; and configured to maintain a position and/or minimize lateral movement of the food container 115—between the first and second conveyor belt such that the amount of scrub (or “friction”) between the rim of the food container 115 and the first and second conveyor belt is below a friction threshold—as the first and second conveyor belt advance and rotate the food container 115 under the set of food dispensing modules 124, as shown in FIG. 4.

The first and second conveyor belt can accommodate food containers 115 of various depths without necessitating a physical change to the food production system 102. The pair of conveyor belts of each conveyor module 130: are laterally offset by approximately a common width (e.g., diameter) of these food containers 115; are offset above a base of the food production system 102 by more than a maximum food container 115 height (e.g., 6.0″) to avoid spilled food; and cooperate to support the underside of the rim of each food container 115 at two narrow areas (e.g., “points” or “arcs”) on opposite sides of the rim. For example, a first conveyor belt 132 of a pair of conveyor belts can be configured to contact and support a first arc of the food container 115, the first arc defining a first arc length less than 5% of a circumference of the food container 115. Further, a second conveyor belt 134 of the pair of conveyor belts can be configured to contact and support a second arc of the food container 115, the second arc opposite the first arc and defining a second arc length less than 5% of the circumference of the food container 115. The configuration of the conveyor module 130 enables the conveyor module 130 to support the rims of various depths of food containers 115 at the same target height such that bottoms of deeper food containers 115 will extend closer to the bottom of the module housing 122 than bottoms of shallower food containers 115. For example, a conveyor module 130 is configured to: support the rim of a first food container 115 of a first depth at a target distance beneath the output of the food dispensing module 124; and support the rim of a second food container 115 of a second depth, greater than the first depth, at the target distance beneath the output of the food dispensing module 124. The conveyor module 130 supports the first and second food containers 115 such that the base of the second food container 115 is suspended closer to a bottom of the module housing 122 than the base of the first food container 115.

### 4.5 Food Containers

The food production system 102 is configured to store, load, and output round food containers 115 (or “bowls”) of a common diameter (e.g., 10″). In one variation, a first instance of the food production system 102 in a make line includes a cluster of container dispensing modules 125 configured to house food containers 115 of different depths (e.g., 3.0″ to 5.0″) and common diameters and, therefore, different volumes (e.g., small, medium, large volumes). The first and second conveyor belt can also maintain top edges of food containers 115 of any depth at common vertical positions (e.g., the target height) under the food dispensing module 124—such as 0.5″ below output ports of the food dispensing modules 124 to enable ingredients to fully empty from these food dispensing modules 124 while limiting opportunity for these ingredients to overflow and/or spill out of these food containers 115.

For example, the set of container dispensing modules 125 can include: a first container dispensing module 125 configured to dispense containers of a first size (e.g., medium) with a first depth (e.g., 4.0″) and configured for loading with ingredients of a first food product (e.g., cold food bowls, such as for an acai food order); a second container dispensing module 125 configured to dispense containers of a second size (e.g., large) with a second depth (e.g., 5.0″) and configured for loading with ingredients of a second food product (e.g., hot food bowls, such as for a chicken caesar salad food order); a third container dispensing module 125 configured to dispense containers of the first size and configured for loading with units of a second food product (e.g., hot food bowls); a fourth container dispensing module 125 configured to dispense containers of the second size and configured for loading with units of the second food product; and a fifth container dispensing module 125 configured to dispense containers of a third size (e.g., small) and configured for loading with volumes of sauces, dressings, and/or dips.

However, because the food containers 115 of difference sizes exhibit similar rim diameters and geometries, and because the first and second conveyor belt are offset above the base of the food production system 102 by more than the maximum food container 115 height, the first and second conveyor belt can receive and manipulate food containers 115 of any of these sizes.

Therefore, the food production system 102 can be configured to load, fill, and output container dispensing modules 125 characterized by a range of sizes and/or depths and can locate these food containers 115 on the first and second conveyor belt before reaching output ports of the food dispensing modules 124 without physical change or reconfiguration of the first and second conveyor belt, the food dispensing modules 124, or container dispensing modules 125 within the food production system 102.

### 4.6 Controller

The food production system 102 can include a controller configured to intake food orders from patrons and to selectively actuate the food processing and dispensing modules to construct instances of a food product according to these food orders. More specifically, the autonomous assembly zone 120 can include an integrated controller configured to: receive or access orders submitted by patrons via a user interface (e.g., arranged on a customer-facing façade of the food production system 102, arranged within a food establishment such as a ghost kitchen, or within a native food ordering application executing on a user's mobile computing device) and/or via direct interaction with an employee; and handle autonomous fulfillment of these orders by triggering actuation of food dispensing and processing modules in the food production system 102, such as via the historical data described below. Furthermore, the controller can be configured to locally actuate the sets of conveyor belts of the conveyor modules 130 to advance and manipulate food containers 115 to receive dispensation of ingredients from food dispensing modules 124 within the food production system 102.

The autonomous assembly zone 120 can also include a wireless communication module coupled to the controller and configured to: receive food orders from patrons; communicate errors, order fulfillment data, and/or fill status of food dispensing modules 124 in the food production system 102 to a computer system (e.g., remote server); and receive control-related updates executable by the controller when processing food orders. Alternatively, the controller and the wireless communication module (and/or other controls- and communications-related subsystems) can be arranged in a controls module configured to transiently install in a food production system 102.

In one variation, the controller can be configured to locally control dispensation of metered volumes of an ingredient contained in this food dispensing module 124—such as by implementing closed-loop controls to drive actuators in the food dispensing module 124 based on outputs of various sensors integrated into the food dispensing module 124—responsive to receipt of a command from the controller to dispense this amount of the ingredient.

### 4.7 Computer System

The computer system (e.g., remote server, computing device) can receive non-optical and/or optical data from the controller and/or one or more sensors installed in the food production system 102 and can manipulate these data to: track and display errors to an employee; update order fulfillment data; and/or to update fill status of food dispensing modules 124 in the food production system 102. Furthermore, the computer system can generate predictions and target locations—executed by the controller—to minimize ordering excess ingredients (e.g., due to wasted ingredients, due to overfilling food orders, due to incorrect food orders), to balance the weight of ingredients in each food container 115 during assembly, and to achieve a particular visual presentation of ingredients within each food container 115 based on these data.

In one variation, the computer system can generate predictions for a likelihood of an order containing a series of ingredients for dispensation. Additionally or alternatively, the computer system can generate target locations for ingredient dispensation, based on historical data of food orders—assembled at the food establishment within a time period (e.g., one day, one week, one month)—from an ordering system, to balance the weight of ingredients in each food container 115 during assembly.

For example, the computer system can: access a list of menu items—labeled with recipes containing ingredients, weights of ingredients, and rotation angles—and extract data during a particular day of the week (e.g., Friday) in which the food establishment fulfilled an approximate amount of food orders (e.g., 32 orders) for a first menu item, from the list of menu items. Then, the computer system can generate a prediction for an amount of a first ingredient to fulfill the approximate amount of food orders for the next occurrence of the particular day of the week, thereby minimizing excess ingredients ordered by an employee of the food establishment (e.g., due to wasted ingredients, due to overfilling food orders, due to incorrect food orders). Furthermore, the computer system can generate target locations (e.g., regions of the food container 115) for dispensation of the first ingredient—executed locally by the controller—into a food container 115 on the first and second conveyor belt in order to balance the weight of the first ingredient in the food container 115 and to achieve a particular presentation of the first ingredient in the food container 115.

Accordingly, the computer system can implement and repeat these methods and techniques for: each other ingredient of each other menu item; each other food container 115; and each other particular day of the week to generate predictions for an amount of each ingredient to fulfill the approximate amount of food orders for the next occurrence of the particular day of the week and to generate target locations for dispensation of each ingredient.

Therefore, the computer system can generate predictions and target locations—executed locally by the controller—to help eliminate food waste and cost, to balance the weight of ingredients in each food container 115 during assembly, and to achieve a particular visual presentation of ingredients within each food container 115.

### 4. Sensors

The food production system 102 can include a set of sensors coupled to the sequence of food hopper located on the food preparation surface of the manual assembly zone 110 and the sequence of food dispensing modules 124 of the autonomous assembly zone 120. The set of sensors can be configured to record temperatures of ingredients contained in the sequence of food hopper and/or the sequence of food dispensing modules 124 (e.g., coextensive or separated the sequence of food hopper) to monitor food quality and food safety of these ingredients over time. Furthermore, the set of sensors can be configured to record ingredient levels of ingredients (e.g., weight in ounces, volume of a food hopper 114 filled, percentage of the food hopper 114 filled, quantity of servings remaining) stored within the food production system 102 (e.g., in the sequence of food hopper and/or food dispensing modules 124), the ingredient level corresponding to an amount remaining of a particular ingredient loaded in a food hopper 114 and/or food dispensing module 124 within the food production system 102.

### 4.1 Level Sensors

For example, the food production system 102 can include a first food dispensing module 124 extending downward from the preparation surface of the manual assembly zone 110 into the autonomous assembly zone 120. The first food dispensing module 124 can include: a food hopper 114 configured to supply units of a first ingredient for manual preparation of units of a food product type in the manual assembly zone 110 and autonomous preparation of units of the food product type in the autonomous assembly zone 120; and an automatic dispenser coupled to the food hopper 114 and configured to selectively dispense units of the first ingredient according to food orders received from patrons (e.g., via the controller).

In this example, the food hopper 114 can include: a manual side arranged proximal the food preparation surface and configured to transiently store ingredients for manual preparation of units of the food product type; and an autonomous side arranged proximal the automatic dispenser, below the manual side, and configured to transiently store ingredients for autonomous preparation of units of the food product type. The food production system 102 can include: a first level sensor (e.g., a depth sensor) coupled to the manual side of the food hopper 114 and configured to record a first remaining amount (e.g., by weight, by fill level, by volume percentage) of the first ingredient within the manual side; a second level sensor coupled to the autonomous side of the food hopper 114 and configured to record a second remaining amount of the first ingredient within the autonomous side; and a temperature sensor coupled to the food hopper 114 and configured to record a temperature (e.g., an average or representative temperature) of units of the first ingredient stored within the food hopper 114.

### 4.2 Optical Sensors

Additionally, optical sensors can be arranged throughout the autonomous assembly zone 120 for process monitoring of food containers 115 as each food container 115 receives ingredients during assembly. Then, the computer system can receive images from this second set of optical sensors and track the rotation of each food container 115 during assembly. The computer system can track the rotation of each food container 115 to ensure each food container 115 is rotated according to the angle of rotation stored in the recipe for each menu item. Additionally, if the computer system detects angular drift of a food container 115, the computer system can send commands to the controller to update the recipe and/or speeds of the conveyor belts to correct any errors in angular drift.

### 4.3 Weight Sensors

Furthermore, a set of weight sensors 138 (e.g., load cells) can be arranged within the autonomous assembly zone 120 and can be configured to output signals representing weights of food containers 115 carried by the conveyor module 130 in the autonomous assembly zone 120. In one example, the conveyor module 130 can include: a first conveyor belt 132 and a second conveyor belt 134 that cooperate to support short segments of two opposing sides of the rim of a food container 115; a first rail 136 arranged under and vertically supporting a length of the upper segment of the first conveyor belt 132; and a first weight sensor 138 coupled to the first rail 136 and configured to output a first signal corresponding to a weight of the food container 115 carried by the first rail 136 via the first conveyor belt 132. In this example, the conveyor module 130 can similarly include: a second rail 136 arranged under and vertically supporting a length of the upper segment of the second conveyor belt 134; and a second weight sensor 138 coupled to the second rail 136 and configured to output a second signal corresponding to a weight of the food container 115 carried by the second rail 136 via the second conveyor belt 134. Therefore, in this example, the controller can calculate a total weight of the food container 115 and its contents based on a sum of weights carried by the first and second rails 136 and derived from signals received from the first weight sensor 138 and the second weight sensors 138.

In one implementation, a weight sensor 138 is coupled to each rail 136 of a conveyor module 130. For example, a conveyor module 130 of a module housing 122 includes a first rail 136 supporting a first conveyor belt 132 and a second rail 136 supporting a second conveyor belt 134. The weight sensor 138 can couple to a longitudinal center of each rail 136. The weight sensor 138 can include a capacitive sensor, displacement sensor, load cell, or other sensor configured to output a signal corresponding to weight. The weight sensor 138 in the longitudinal center of the first rail 136 outputs a signal corresponding to the weight of a food container 115 on the first conveyor belt 132. The controller can be calibrated to determine an accurate weight of the food container 115 from the value of the signal output by the weight sensor 138.

In another implementation, two weight sensors 138 are coupled to each rail 136 of the conveyor module 130, one weight sensor 138 at a proximal end of the rail 136 (e.g., near the inlet door of a module housing 122) and one weight sensor 138 at a distal end of the rail 136 (e.g., near the outlet door of the module housing 122). The controller can be calibrated to calculate a weight of the food container 115 by adding the values of the signals output by each weight sensors 138. The controller can detect a weight of the food container 115 at any position along a rail 136 of the conveyor module 130 that includes a weight sensor 138.

### 6. Conveyor Module

The food production system 102 can further include a conveyor module 130 configured to install along the autonomous assembly zone 120 and to move a container along a sequence of food dispensing and processing modules as the container is filled with ingredients and processed (e.g., blended, mixed, heated) according to a food order received from a patron.

In one variation, the conveyor module 130 includes a set of (e.g., two) conveyor belts: laterally offset and mirrored across the longitudinal axis of the food production system 102; and cooperating to support short, opposing segments of a rim of a food container 115. The set of conveyor belts of the conveyor module 130 can include: a first conveyor belt 132 extending parallel to and laterally offset behind the longitudinal assembly axis 140; and a second conveyor belt 134 extending parallel to and laterally offset in front of the longitudinal assembly axis 140. The second conveyor belt 134 is configured to cooperate with the first conveyor belt 132 to support a rim of a food container 115 with a base of the food container 115 extending below the first conveyor belt 132 and the second conveyor belt 134.

For example, the first and second conveyor belt: can be configured to be laterally offset by approximately the common width of a set of food containers 115; are offset above a base of the food production system 102 by more than a maximum food container 115 height (e.g., 6.0″); and cooperate to support the underside of the rim of each food container 115 at two narrow areas (or “points”) on opposite sides of the rim. Accordingly, the first and second conveyor belt can accommodate food containers 115 of various depths without necessitating a physical change to the food production system 102. The first and second conveyor belt can therefore also maintain top edges of food containers 115 of any depth at common vertical positions under the food dispensing module 124—such as 0.5″ below output ports of the food dispensing modules 124 to enable ingredients to fully empty from these food dispensing modules 124 while limiting opportunity for these ingredients to spill out of these food containers 115.

Additionally or alternatively, the first and second conveyor belt can be configured to move a food container 115 under the set of food dispensing modules 124 within a predefined tolerance such that the vertical movement of the food container 115 is minimized to within this tolerance. The first and second conveyor belt can also be narrow (e.g., 2 mm-5 mm) such that the first and second conveyor belt support the underside of the rim of each food container 115 by achieving two precise points of contact with opposites sides of the rim of each food container 115. For example, the first conveyor belt 132 second conveyor belt can be configured to contact and support a first arc of the food container 115 while the second conveyor belt 134 can be configured to contact and support a second arc of the food container 115. The second arc is positioned opposite the first arc. The first and second arcs define a first and second arc length of the circumference of the food container 115. Each of the first and second arc lengths define less than 5% of circumference of the food container 115 (e.g., the first and second arc lengths totaling less than 10%).

In another variation, the conveyor module 130 further includes a set of rub rails 136: laterally offset and mirrored across the longitudinal axis of the food production system 102; arranged within a set of guides and below the first and second conveyor belt; configured to support segments of the base of a food container 115; and configured to maintain a position and/or minimize lateral movement of the food container 115—between the first and second conveyor belt—as the first and second conveyor belt advance and rotate the food container 115 under the set of food dispensing modules 124. Additionally or alternatively, each rub rail 136 includes a groove—across the longitudinal axis of the rub rail 136—in order to catch any excess spillage of food during the assembly of a food order. Furthermore, the set of rub rails 136 can be configured to magnetically couple to the frame of the conveyor module 130—below the first and second conveyor belt—thereby enabling an employee: to quickly remove each rub rail 136 to clean the conveyor module 130 of any food spillage during assembly of food orders; and quickly and accurately remove each rub rail 136 for disassembly of the food production system 102 with a single motion away from the frame of the conveyor module 130. For example, the conveyor module 130 can include: a first rub rail 136 arranged under the first conveyor belt 132 of the first and second conveyor belt of the conveyor module 130 and configured to rigidly support a first section of the first conveyor belt 132 in contact with the rim of the food container 115; and second rub rail 136 arranged under the second conveyor belt 134 and configured to rigidly support a second section of the second conveyor belt 134 in contact with the rim of the food container 115.

In yet another variation, the conveyor module 130 can be configured to receive food containers 115 from a container dispensing module 125 (or “de-nesting unit”). The container dispensing module 125 can include a set of screws configured to support a set of food containers 115 and configured to rotate and/or release each food container 115 in the set of food containers 115 onto the first and second conveyor belt of the conveyor module 130 such that the rim of each food container 115 is arranged to contact the conveyor belts.

For example, the container dispensing module 125 can be arranged within an initial module housing 122 of a sequence of module housings 122 to dispense food containers 115 to subsequent module housings 122. The container dispensing module 125 is arranged adjacent to a subsequent module housing 122 and dispenses a food container 115 into the inlet door and onto the conveyor module 130 of the subsequent module housing 122. The controller is configured to trigger the container dispensing module 125 to dispense a food container 115 responsive to receiving a food order for assembly within the autonomous assembly zone 120.

Furthermore, a final conveyor module 130 in a final module housing 122 can be configured to move food containers 115 to a food elevator to complete assembly of a food order. The food elevator can be configured to: lift the base of each food container 115 from between the first and second conveyor belt; and direct the assembled food container 115 toward the food preparation surface for collection by an employee and/or presentation to a patron. The elevator module 127 is arranged in a final module housing 122 of a sequence of module housings 122 (e.g., a last module housing 122 of the food production system 102 “downstream” of other module housings 122 in which ingredients are dispensed by food dispensing modules 124) to receive a food container 115 with a complete set of ingredients (e.g., having each ingredient specified in the food order). The final module housing 122 containing the elevator module 127 can include an inlet door configured to receive the food container 115 with the complete set of ingredients. In one implementation, the final module housing 122 can include a final conveyor module 130 configured to align the food container 115 above the elevator module 127 to be lifted to the food preparation surface.

In another variation, the food production system 102 can be configured to prepare multiple food orders simultaneously. In particular, the conveyor module 130 can be configured to transfer multiple containers along the sequence of the food dispensing and processing modules concurrently such that the food production system 102 can output a continuous sequence of food orders. For example, at a first time, the first and second conveyor belt can receive a first food container 115 at an initial position. Then, at approximately a second time, the first and second conveyor belt can: move the first food container 115 from the initial position to a first position at a first food dispensing module 124; and receive a second food container 115 at the initial position. At approximately a third time, the first and second conveyor belt can: move the first food container 115 from the first position to a second position at a second food dispensing module 124; move the second food container 115 from the initial position to the first position; and receive a third food container 115 at the initial position. Therefore, the food production system 102 can begin assembly of additional food orders in the food order queue before completing previous food orders in the food order queue, thus maximizing throughput of food order completion.

### 6.1 Weighted Balance of Ingredients+Linear Motion

In one implementation, the controller can actuate the first and second conveyor belt at similar speeds and/or by similar distances in the same direction to move a food container 115 in a linear motion (e.g., forward, backward) between food dispensing modules 124 along the food production system 102.

In one example, the food production system 102 is configured to fulfill a patron's order for a chicken caesar salad. Accordingly, the food production system 102 can include a cluster of food dispensing modules 124 (e.g., 8 food dispensing modules 124) including: a first set of food dispensing modules 124 arranged in a first stage in the autonomous assembly zone 120, along the longitudinal assembly axis 140 of the food production system 102 (e.g., opposite of an employee working at the food production system 102); and a second set of food dispensing modules 124 arranged in a second stage in the autonomous assembly zone 120, along the longitudinal assembly axis 140 of the food production system 102 (e.g., opposite of an employee working at the food production system 102), and adjacent the first stage.

In this example, responsive to entry of a first food container 115 onto the first and second conveyor belt in the conveyor module 130, the controller can: receive an image from an optical sensor defining a field of view intersecting the conveyor module 130; identify the first food container 115 within the image; access a first list of menu items labeled with recipes of ingredients and angles of rotations; extract a first menu item of chicken caesar salad associated with the first food container 115; scan the food production system 102 for food dispensing modules 124 that contain ingredients according to the recipe for chicken caesar salad; and activate pre-feeding of base ingredients and intermediate ingredients at each food dispensing module 124.

At approximately a first time, the controller can actuate the first and second conveyor belt to move the first food container 115 into a first position in the first stage to receive dispensation of a first base ingredient (e.g., a bed of greens) with a large mass (e.g., greater than a predefined ingredient mass threshold). At approximately a second time, the controller can actuate the first and second conveyor belt to move the first food container 115 forward (e.g., toward the food elevator) to a second position in the second stage to receive a first intermediate ingredient (e.g., a hot ingredient such as chicken) from the second set of food dispensing modules 124 according to the recipe for chicken caesar salad. At approximately a third time, the controller can actuate the first and second conveyor belt to move the first food container 115 backward (e.g., toward the container dispensing module 125) to a third position in the first stage to receive a second intermediate ingredient (e.g., a cold ingredient such as parmesan cheese) from the first set of food dispensing modules 124. At approximately a fourth time, the controller can actuate the first and second conveyor belt to move the first food container 115 forward (e.g., toward the food elevator) to a fourth position in the second stage to receive a third intermediate ingredient (e.g., dry ingredient such as croutons) from the second set of food dispensing modules 124. Then, the controller can actuate the first and second conveyor belt to move the first food container 115 to any additional liquid dispensing modules (e.g., dressings, sauces) and/or food dispensing modules 124 for toppings (e.g., ingredients with negligible weight) to complete the food order according to the recipe for chicken caesar salad.

Therefore, the controller can actuate the first and second conveyor belt in order to assemble food orders with a particular series of ingredient dispensation such that a base ingredient is dispensed first into the food container 115, followed by intermediate ingredients, and then followed by liquids and/or toppings. The target locations and particular series of ingredient dispensation maintain a balanced weight of ingredients in the food container 115 after each ingredient is dispensed and as the food container 115 moves along the first and second conveyor belt to each food dispensing module 124.

### 6.2 Weighted Balance of Ingredients+Non-Linear Motion

In one implementation, the controller can actuate the first and second conveyor belt to move food containers 115 non-linearly for dispensation of ingredients to fulfill a series of food orders. In particular, the controller can actuate the first and second conveyor belt at dissimilar speeds and/or by dissimilar distances and in the same direction to concurrently rotate and translate the food container 115 between food dispensing modules 124. Similarly, the controller can actuate the first and second conveyor belt at similar speeds and/or by similar distances and in opposite directions to concurrently rotate the food container 115 while the food container 115 remains in the same longitudinal position under one group of food dispensing modules 124.

Generally, responsive to entry of a first food container 115 onto the first and second conveyor belt in the autonomous assembly zone 120, the controller can: receive an image from an optical sensor defining a field of view intersecting the conveyor module 13o; identify the first food container 115 within the image; access a first list of menu items labeled with recipes of ingredients and angles of rotations; extract a first menu item associated with the first food container 115; scan the food production system 102 for food dispensing modules 124 that contain ingredients from the recipe; activate pre-feeding of base ingredients and intermediate ingredients at each food dispensing module 124; and actuate the first and second conveyor belt to move the first food container 115 into a first position for dispensation of a base ingredient (e.g., bed of greens, grains) at a first food dispensing module 124 based on the recipe from the first menu item. The controller can then actuate the first and second conveyor belt at dissimilar speeds to rotate the first food container 115 (e.g., 45 degrees, 90 degrees, 180 degrees, 360 degrees) to receive dispensation of a first intermediate ingredient (e.g., cucumbers, tomatoes, croutons, scallions, sesame seeds etc.) according to an angle of rotation from the first menu item. The controller can implement and repeat these methods and techniques for each other food container 115 in a stack of food containers 115 in a container dispensing module 125 to complete the series of food orders received from patrons (e.g., via the controller).

More specifically, the controller can actuate the first and second conveyor belt at dissimilar speeds and/or by dissimilar distances and in opposite directions to concurrently rotate a food container 115 180 degrees to receive an ingredient from adjacent food dispensing modules 124 in order to improve the cycle time for the assembly of the food order.

In one variation, the food dispensing module 124 outputs can be arranged in two parallel rows, one row of food dispensing module 124 outputs on each side of the longitudinal assembly axis 140 while the conveyor module 130 runs along the longitudinal assembly axis 140. In this arrangement, rotation of the food container 115 may be necessary for the food container 115 to reach each food dispensing module 124. For example, a first food dispensing module 124 output can be arranged on a first side of the longitudinal assembly axis 140 and a second food dispensing module 124 output on a second side of the food dispensing module 124, the two food dispensing module 124 outputs aligned longitudinally. The controller triggers the conveyor module 130 to rotate the food container 115 from a first position to align a first region of the food container 115 under the first food dispensing module 124 output and then to a second position to align the first region of the food container 115 under the second food dispensing module 124 output, thereby receiving a first and second ingredient into the first region of the food container 115.

In this variation, the controller is configured to: advance the food container 115 within the module housing 122 to locate the first region of the food container 115 centered beneath the first food dispensing module 124 (on the first side of the longitudinal assembly axis 140) by triggering both the first conveyor belt 132 and the second conveyor belt 134 to advance in a first longitudinal direction by a first distance 142; trigger the first food dispensing module 124 to dispense a first portion of a target mass of the first ingredient into the first region of the food container 115; rotate the food container 115 to locate a third region of the food container 115, opposite the first region, centered beneath the first food dispensing module 124; and trigger the first food dispensing module 124 to dispense a second portion of the target mass of the first ingredient into the third region of the food container 115.

The controller is configured to rotate the food container 115 to locate a third region of the food container 115, opposite the first region, centered beneath the first food dispensing module 124 by: triggering the first conveyor belt 132 to advance in the first longitudinal direction by a fourth distance; and triggering the second conveyor belt 134 to advance in a second longitudinal direction opposite the first longitudinal direction by the fourth distance.

### 6.2.1 Example: Food Dispensing Modules Parallel to the Longitudinal Assembly Axis

In one example, the food production system 102 is configured to fulfill a patron's order for a chicken caesar salad. Similar to a previous example, the food production system 102 can include a cluster of food dispensing module 124 outputs (e.g., 8 food dispensing module 124 outputs) including: a first set of food dispensing module 124 outputs arranged in a first stage in the autonomous assembly zone 120, along the longitudinal axis of the food production system 102 (e.g., opposite of an employee working at the food production system 102); and a second set of food dispensing module 124 outputs arranged in a second stage in the autonomous assembly zone 120, along the longitudinal axis of the food production system 102 (e.g., opposite of an employee working at the food production system 102); and adjacent the first stage.

In this example, the controller can implement methods and techniques described above to prepare and actuate the first and second conveyor belt to move the first container into a first position in the first stage to receive dispensation of a first base ingredient (e.g., a bed of greens). Then, at approximately a second time, the controller can actuate the first and second conveyor belt to move the first food container 115 forward (e.g., toward the food elevator) to a second position in the second stage to receive a first intermediate ingredient (e.g., a hot ingredient such as chicken) from a first food dispensing module 124 of the second set of food dispensing modules 124. At approximately a third time, the controller can actuate the first and second conveyor belt at dissimilar speeds to rotate the first food container 115 180 degrees (e.g., toward the food elevator) into a third position in the second stage to receive a second intermediate ingredient (e.g., parmesan cheese) from a second food dispensing module 124 of the second set of food dispensing modules 124. Then, the controller can actuate the first and second conveyor belt to move the first food container 115 to any additional intermediate ingredients from the first or second stage, to any liquid dispensing modules (e.g., dressings, sauces) and/or food dispensing modules 124 for toppings (e.g., ingredients with negligible weight) to complete the food order according to the recipe for chicken caesar salad.

Additionally or alternatively, the controller can actuate the first and second conveyor belt to receive ingredients from adjacent food dispensing modules 124 in the second set of food dispensing modules 124 in order to improve the cycle time for assembly of the food order. For example, the controller can implement methods and techniques described above to prepare and actuate the first and second conveyor belt to move the first food container 115 to receive dispensation of the first base ingredient (e.g., a bed of greens) and then to a second position to receive dispensation of the first intermediate ingredient (e.g., hot ingredient such as chicken). Then, at approximately a third time, the controller can actuate the first and second conveyor belt to rotate the first food container 18o degrees (e.g., toward the food elevator) to a third position in the second stage to receive a second intermediate ingredient (e.g., a cold ingredient such as parmesan cheese) from a first food dispensing module 124 of the second set of food dispensing modules 124. Simultaneously, the first food container 115 can receive a third intermediate ingredient (e.g., dry ingredient such as croutons) from a second food dispensing module 124 of the second set of food dispensing modules 124, thereby dispensing two intermediate ingredients (e.g., parmesan cheese and croutons) simultaneously.

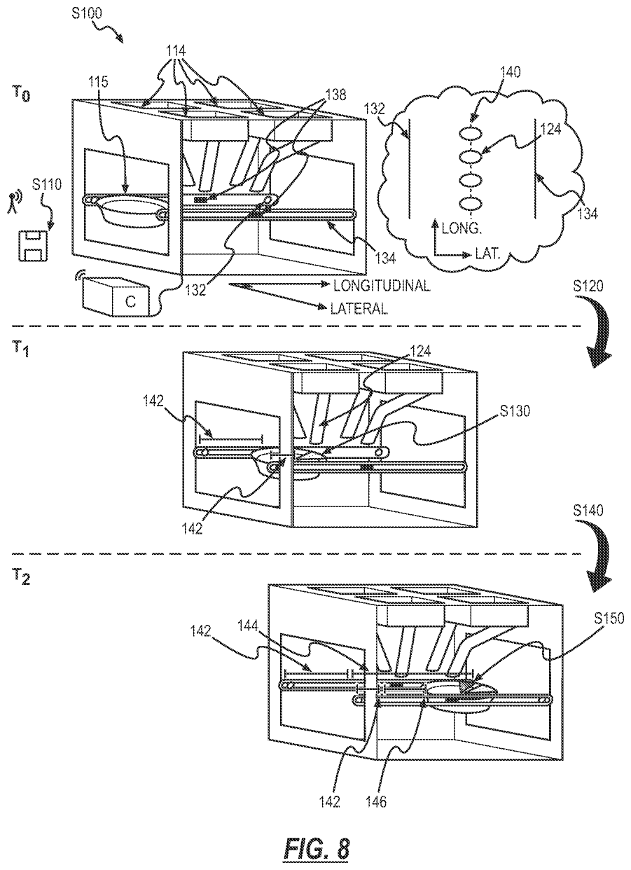

In one variation, the outputs of food dispensing modules 124 in the module housing 122 are aligned over the longitudinal assembly axis 140 and approximately centered between the first and second conveyor belt—shown in FIG. 8. For example, the first food dispensing module 124 output can be laterally centered over the longitudinal assembly axis 140, and the second food dispensing module 124 output is laterally centered over the longitudinal assembly axis 140 and is longitudinally offset from (i.e., downstream of) the first food dispensing module 124 output. In this example, the controller can advance the food container 115 to locate the first region of the food container 115 centered beneath the first food dispensing module 124 output, laterally centered along the longitudinal assembly axis 140, and located between the first conveyor belt 132 and the second conveyor belt 134. The controller advances the food container 115 by triggering the first conveyor belt 132 and the second conveyor belt 134 to advance by a first distance 142. In this example, the second distance 144 can approximate a distance from an inlet door of the module housing 122 to a center of the output of the first food dispensing module 124.

The controller can then concurrently advance and rotate the food container 115 to locate the second region of the food container 115 centered beneath the second food dispensing module 124 output, laterally centered along the longitudinal assembly axis 140, and located between the first conveyor belt 132 and the second conveyor by: triggering the first conveyor belt 132 to advance by the second distance 144; and triggering the second conveyor belt 134 to advance by the third distance 146 different from the second distance 144. In this example, the second distance 144 can approximate a sum of: a longitudinal (or “pitch”) distance between centers of the outputs of the first and second food dispensing module 124; and a length of a segment of the rim of the food container 115 from the first region to the second region of the food container 115. Similarly, the third distance 146 can approximate: the longitudinal distance between centers of the outputs of the first and second food dispensing module 124; less the length of the segment of the rim of the food container 115 from the first region to the second region of the food container 115.

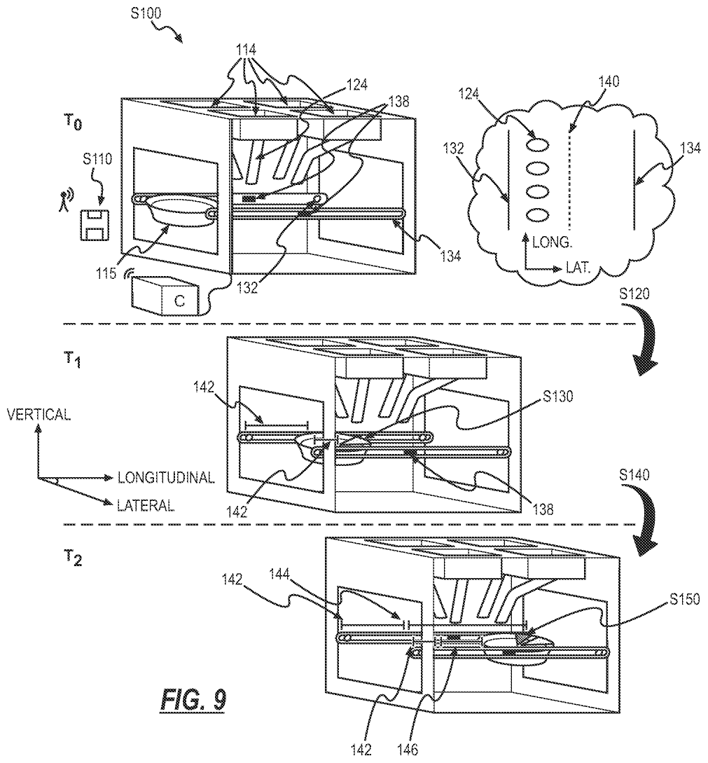

In another variation, the food dispensing module 124 outputs can be arranged along an axis that is parallel to and laterally offset from the longitudinal assembly axis 140—shown in FIG. 9. In one example, the first food dispensing module 124 output is laterally offset the longitudinal assembly axis 140 and biased toward the second conveyor belt 134. The second food dispensing module 124 output is laterally offset the longitudinal assembly axis 140 and biased toward the second conveyor belt 134. The second food dispensing module 124 output is longitudinally offset from the first food dispensing module 124 output.

In this variation, the controller is configured to: advance the food container 115 to locate the first region of the food container 115 centered beneath the first food dispensing module 124 output, laterally offset from the longitudinal assembly axis 140, and located adjacent the second conveyor belt 134 by triggering the first conveyor belt 132 and the second conveyor belt 134 to advance by the first distance 142; advance and rotate the food container 115 to locate the second region of the food container 115 centered beneath the second food dispensing module 124 output, laterally offset from the longitudinal assembly axis 140, and located adjacent the second conveyor belt 134. The controller advances and rotates the food container 115 by: triggering the first conveyor belt 132 to advance by the second distance 144; and triggering the second conveyor belt 134 to advance by the third distance 146 different from the second distance 144.

### 6.2.2 Example: Front and Rear Food Dispensing Modules

In another example, the food production system 102 is configured to fulfill the patron's order for the chicken caesar salad. Accordingly, the food production system 102 can include a cluster of outputs of the food dispensing modules 124 (e.g., 8 food dispensing modules 124) including a first set of food dispensing module 124 outputs and a second set of food dispensing module 124 outputs such that the first and second set of food dispensing outputs are arranged parallel and opposite each other across the longitudinal assembly axis 140 in the autonomous assembly zone 120. Furthermore, the first set of food dispensing module 124 outputs are arranged in a first stage, in a front side of the autonomous assembly zone 120 (e.g., along the front side of the lateral axis of the food production system 102 where an employee stands), and the second set of food dispensing module 124 outputs are arranged in the first stage, in a rear of the autonomous assembly zone 120 (e.g., along the rear of the lateral axis of the food production system 102 opposite of where an employee stands).

In this example, the controller can implement methods and techniques described above to prepare and actuate the first and second conveyor belt to move the first container into a first position in the first stage to receive dispensation of a first base ingredient (e.g., a bed of greens) from the first set of food dispensing modules 124. Then, at approximately a second time, the controller can actuate the first and second conveyor belt to rotate the first food container 115 180 degrees (e.g., toward the food elevator) to a second position in the first stage to receive a first half of a first intermediate ingredient (e.g., a hot ingredient such as chicken) from a first food dispensing module 124 in the front of the autonomous assembly zone 120. Simultaneously, the first food container 115 can receive a second half of the first intermediate ingredient from a second dispensing module in the back of the autonomous assembly zone 120, thereby dispensing two halves of the first intermediate ingredient (e.g., chicken) into two sides of the first food container 115 to maintain weighted balance of ingredients.

### 6.2.2 Example: Radially-Patterned Food Dispensing Modules

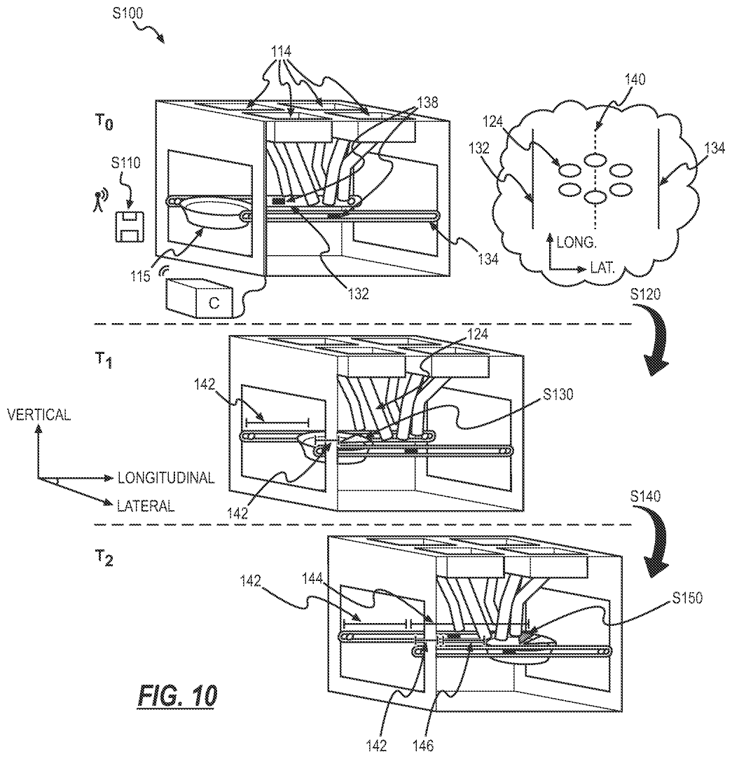

Furthermore, the outputs first food dispensing module 124 and the second food dispensing module 124 can be arranged in a radial pattern over the longitudinal assembly axis 140 of the autonomous assembly zone 120—shown in FIG. 10. In this arrangement, multiple food dispensing modules 124 can dispense ingredients into opposing regions of the food container 115 simultaneously or rotate the food container 115 to dispense a first ingredient into a first region followed by dispensing a second ingredient into a second region. In one example, the radial pattern of food dispensing module 124 can include a number of food dispensing modules 124 equal to the number of region of the food container 115 (e.g., 6 food dispensing modules 124 for a 6-region food container 115). Each food dispensing module 124 is arranged to align over a region of the food container 115. In one example, the controller can align the food container 115 beneath the radial pattern on food dispensing modules 124 and trigger all of the food dispensing modules 124 to dispense ingredients within a single interval of time. This example enables high-throughput applications of the food production system 102 such as for catering businesses or cafeterias.

Minimal translation (e.g., in the longitudinal direction) is necessary for dispensing ingredients with the radial patterned food dispensing module 124. The controller rotates the food container 115 beneath the radial pattern of food dispensing modules 124 to align a target region of the food container 115 with a target food dispensing module 124 and dispense the ingredient from the target food dispensing module 124 into the target region. The controller repeats this process to align regions of the food container 115 with the food dispensing modules 124 according to the plating instruction.

The controller is configured to advance the food container 115 to locate the first region of the food container 115 centered beneath the first food dispensing module 124. The controller triggers the first conveyor belt 132 and the second conveyor belt 134 to: advance in a first longitudinal direction by the first distance 142; and rotate the food container 115 to locate the second region of the food container 115 centered beneath the second food dispensing module 124. The controller rotates the food container 115 by: triggering the first conveyor belt 132 to advance in the first longitudinal direction by the second distance 144; and triggering the second conveyor belt 134 to advance in a second longitudinal direction opposite the first longitudinal direction by the third distance 146 equal to the second distance 144.

However, the controller can additionally or alternatively implement methods and techniques described above to complete food orders with any other configuration of food dispensing modules 124 and/or with any other angle of rotation and can interface with food dispensing modules 124, processing modules, and the first and second conveyor belt in any other way.

### 6.3 Food Container Balancing

In one variation, the food production system 102 further includes a set of weight sensors 138 coupled to the rails 136 and configured to output a signal to the controller indicating a weight on the sensor or on the surface the sensor is coupled to. In one implementation, the food production system 102 includes a first weight sensor 138 coupled to a first rail 136 supporting the first conveyor belt 132 and a second weight sensor 138 coupled to the second rail 136 supporting the second conveyor belt 134. The first weight sensor 138 outputs a signal corresponding to a first weight of the food container 115 carried by the first conveyor belt 132; and the second weight sensor 138 outputs a second signal corresponding to a second weight of the food container 115 carried by the second conveyor belt 134. The controller can calculate the total weight of a food container 115 on a conveyor module 13o by adding the first weight and the second weight. The controller can additionally derive the center of mass of the food container 115 from the weight sensor 138 outputs.

For example, the controller can: receive the first signal from the first weight sensor 138; receive the second signal from the second weight sensor 138; calculate a lateral center of mass of the food container 115 based on the first signal and the second signal; and define the second region of the food container 115 corresponding to a greatest distance, within the food container 115, from the lateral center of mass of the food container 115. Therefore, the controller calculates a position of the second region of the food container 115—into which to dispense a next ingredient—in order to: maintain the lateral center of mass of the food container 115 and its contents near a center of the food container 115; prevent deformation of opposing segments of the rim of the food container 115 due to uneven loading on the first and second conveyor belt; and prevent the food container 115 from tipping and spilling its contents due to imbalance, such as when the controller subsequently rotates the food container 115 by triggering the first and second conveyors to move in opposite directions or at different speeds.

The controller can further rotate the food container 115 ninety degrees by: triggering the first conveyor belt 132 to advance in a first longitudinal direction by a fourth distance; and triggering the second conveyor belt 134 to advance in a second longitudinal direction opposite the first longitudinal direction by the fourth distance. The controller can then calculate a second lateral center of mass of the food container 115 based on the first signal and the second signal; calculate a two-dimensional center of mass of the food container 115 based on the first lateral center of mass and the second lateral center of mass; and define the third region of the food container 115 corresponding to a greatest distance, within the food container 115, from the two-dimensional center of mass of the food container 115. Therefore, the controller selects the third region as a target region to dispense a next ingredient. The controller selects the target region for the next ingredient to locate the center of mass of the food container 115 closer to the center of the food container 115 to improve the balance of the food container 115.

### 6.4 Dispensing Rules

In one implementation, the controller stores a set of dispensing rules. The dispensing rule include a set of instructions for dispensing ingredients and maneuvering a food container 115 to reduce incidence of tipping and spilling. Each dispensing rule indicates that the controller detects the center of mass of the food container 115 before dispensing a first ingredient, and after dispensing each ingredient. The dispensing rules indicate a behavior of the controller responsive to the center of mass value.

In one example, the dispensing rules indicate a priority to locate the center of mass of the food container 115 at the center of the food container 115. This dispensing rule can be triggered by the controller detecting a food container 115 over a threshold weight (e.g., over 500 g). For example, when the dispensing rule is triggered, the controller maneuvers the food container 115 to dispense ingredients into regions to center the center of mass within the food container 115 rather than dispensing ingredients into regions according to plating instructions.

In another example, the dispensing rules indicate a balanced priority for visual appeal (e.g., adherence to the plating instructions) and center of mass control. This dispensing rule can be triggered by default for each food container 115 until the weight of the food container 115 triggers the dispensing rule described above. In this example, the controller triggers the food dispensing module 124 to dispense ingredients into regions of the food container 115 according to the plating instruction until the center of mass of the food container 115 is outside of a target zone (e.g., more than 5 cm radius from the center of the food container 115). In response to the center of mass outside of the target zone the controller triggers the conveyor module 130 and food dispensing module 124 to dispense the next ingredient into a region of the food container 115 that will move the center of mass toward into the target zone. After that ingredient is dispensed the controller detects the center of mass of the food container 115. In response to the center of mass still outside the target zone, the controller dispenses the next ingredient as described above to move the center of mass into the target zone. In response to the center of mass back within the target zone, the controller dispenses the next ingredient according to the plating instruction for visual appeal.

Other dispensing rules may indicate that the controller split ingredients into multiple portions to spread the mass of the ingredient across the food container 115. In one example, the controller triggers the food dispensing module 124 to dispense a first portion of an ingredient (e.g., a heavy ingredient like meat) into a first region of the food container 115 and a second portion of the ingredient into a second region opposite the first region to balance the food container 115. In this example, the first and second portion of the ingredient each represent half of the total mass of the ingredient to be dispensed.

In another example, the dispensing rules indicate that the food container 115 be rotated during dispensing of an ingredient to spread an ingredient evenly over multiple regions. This dispensing rule may be triggered by certain ingredients such as toppings (e.g., salt) or sauces (e.g., salad dressing). Another dispensing rule can indicate that two ingredients be dispensed one after the other on opposite regions of the food container 115 to balance the food container 115. The dispensing rule indicates that the conveyor module 130 not rotate the food container 115 between the two ingredients to prevent tipping. This rule conveyor arm be triggered for ingredients over a threshold weight (e.g., over boog).

### 6.5 Segmented Conveyor Module

In one implementation, the conveyor module 130 can be segmented within a module housing 122 such that the conveyor module 130 can move different food orders individually and/or non-linearly (e.g., at different rates, to different food dispensing modules 124) within the food production system 102.

In one implementation, the food production system 102 includes a sequence of conveyor modules 130 arranged within the sequence of module housings 122 adjacent the sequence of food dispensing modules 124. In this implementation, each module housing 122 can include a conveyor module 130, in the sequence of conveyor modules 130, extending between an inlet and an output of the corresponding module housing 122. Further, the conveyor module 130 can include a set of connector features configured to align and/or couple contiguous conveyor modules 130, in the sequence of conveyor modules 130, such that the sequence of conveyor modules 130 can cooperate to transfer food containers 115 between module housings 122 and along the sequence of food dispensing modules 124. Additionally or alternatively, in this implementation, the conveyor module 130 can include a set of conveyor handoffs configured to transfer food containers 115 between contiguous conveyor modules 130 in the sequence of conveyor modules 130.

For example, the conveyor module 130 can be: located within the sequence of module housings 122 adjacent the sequence of food dispensing modules 124; and configured to transfer a first food container 115 along the sequence of food dispensing modules 124 for dispensation of a first set of ingredients into the first food container 115 according to a first food order. In this example, the sequence of module housings 122 can include: a first food module housing 122 configured to transiently house a first set of food dispensing modules 124 in the sequence of food dispensing modules 124; and a second food module housing 122 configured to transiently house a second set of food dispensing modules 124 in the sequence of food dispensing modules 124.

In this example, the conveyor module 130 can include: a first conveyor module 130 arranged within the first food module housing 122 proximal the first set of food dispensing modules 124 within the first food module housing 122; and a second conveyor module 130 arranged within the second module housing 122 adjacent the second set of food dispensing modules 124. The first conveyor module 130 can be configured to transfer the first food container 115 from a first inlet of the first food module housing 122 to a first output of the first food module housing 122, for dispensation of ingredients from the first set of food dispensing modules 124 into the first food container 115. The second conveyor module 130 can be configured to: receive the first food container 115 at a second inlet of the second food module housing 122 from the first output of the first food module housing 122; and transfer the first food container 115 from the second inlet to a second output of the second food module housing 122 for dispensation of ingredients from the second set of food dispensing modules 124 into the food container 115. Thus, the first and second conveyor modules 130 can cooperate to transfer the first container toward corresponding food dispensing modules 124, distributed between multiple module housings 122, for loading the first container with ingredients.

Further, in the preceding example, the controller can actuate the first and second conveyor belt of the first and second conveyor modules 130 independently, thereby reducing wait times for food orders by reducing wait times between dispensation of ingredients in the autonomous assembly zone 120. For example, the controller can: actuate the first and second conveyor belt of the second conveyor module 130 to locate the first container adjacent a first food dispensing module 124, in the second set of food dispensing modules 124, located in the second food module housing 122; and halt actuation of the first and second conveyor belt of the second conveyor module 130 and actuate the first food dispensing module 124 to dispense ingredients into the first food container 115. Simultaneously, during dispensation of ingredients into the first food container 115 on the second conveyor module 130, the controller can: actuate the first and second conveyor belt of the first conveyor module 130 to locate a second food container 115 adjacent a second food dispensing module 124, in the first set of food dispensing modules 124, located in the first food module housing 122.

In another example, the food production system 102 can include: a first conveyor segment (or “conveyor module 130”) extending between a first food dispensing module 124 and a second food dispensing module 124; and a second conveyor segment extending between the second food dispensing module 124 and a third food dispensing module 124. In this example, the controller can actuate the first and second conveyor belt of the first conveyor segment to move a first food container 115 from the first food dispensing module 124 to the second food dispensing module 124. As the first food container 115 is filled with a first ingredient in the first food dispensing module 124, the controller can again actuate the first and second conveyor belt of the first conveyor segment to move a second food container 115 from the first food dispensing module 124 toward the second food dispensing module 124. If, however, the second food container 115 corresponds to a food order not including the first ingredient, the controller can actuate the first and second conveyor belt of the second conveyor segment to move the second food container 115 past the second food dispensing module 124 and toward a third food dispensing module 124. Therefore, the first and second conveyor belt of the first and second conveyor segments can continue to move the second food container 115 past the first food container 115 for filling with other ingredients and/or completion of the food order, rather than wait for the first food container 115 at the second food dispensing module 124.

Additionally or alternatively, in another implementation, the controller can actuate the first and second conveyor belt of the conveyor module 130, to rotate an orientation (e.g., radial orientation) of food containers 115 relative the food dispensing modules 124 in order to achieve a particular presentation of ingredients within these containers. For example, the controller can actuate the first and second conveyor belt to move at dissimilar speeds to rotate a salad bowl radially (e.g., 36o degrees) while ingredients are dispensed from each food dispensing module 124, such that the salad bowl exhibits an approximately even distribution (e.g., radial distribution) of ingredients. In another example, the first and second conveyor belt can be configured to rotate an acai bowl between food dispensing modules 124, such that different ingredients are located in different regions of the acai bowl. In yet another example, the first and second conveyor belt can be configured to shift a food container 115 laterally (e.g., perpendicular a dispense path of ingredients dispensed into the food container 115). Alternatively, in another example, a food ejector (e.g., food dispensing chute) of a food dispensing module 124 can be configured to move positions in order to dispense an ingredient into a particular region of the food container 115.

Therefore, the first and second conveyor belt of the conveyor module 130, can be configured to rotate a radial orientation of food containers 115 to achieve a particular presentation of ingredients and to prevent compounded error in translation of ingredients as the controller actuates movement of each food container 115 between conveyor modules 130, conveyor segments, and/or food dispensing modules 124.

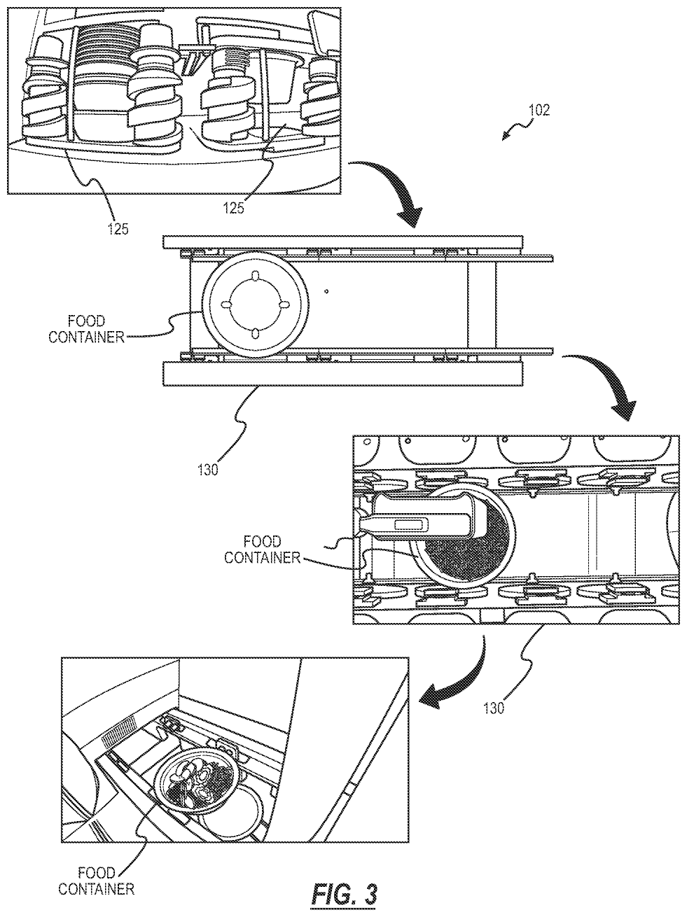

As shown in FIG. 3, one variation of the food production system 102 includes: a container dispensing module 125 configured to dispense containers onto a first and second conveyor belt within the conveyor module 130; the conveyor module 130 located adjacent the container dispensing module 125 and configured to transfer the set of food containers 115 along the sequence of food dispensing modules 124 for dispensation of ingredients into the set of food containers 115; and an elevator module 12′7 (or “food elevator”) located adjacent the conveyor module 130 and configured to direct the assembled food container 115 toward the food preparation surface for collection by a worker and/or presentation to a patron.

### 7. Food Production System Operation

The controller of the food production system 102 executes a series of steps to assemble a unit of the food product type in the autonomous assembly zone 120. The controller triggers components of the food production system 102 to dispense a food container 115, move the food container 115, fill the food container 115, and raise the food container 115 with the completed set of ingredients to the food preparation surface for an operator of the manual assembly zone 110 to collect.

The controller: receives a food order indicating a set of ingredients to be dispensed into a set of regions of a food container 115 comprising the unit of the food product type; triggers a container dispensing module 125 to dispense a food container 115 onto a conveyor module 130 of a first module housing 122; by the conveyor module 130 of the first module housing 122, transfers the food container 115 to an output door of the first module housing 122 abutting an inlet door of a second module housing 122; and by the conveyor module 130 of the second module housing 122, transfers the food container 115 from the output door of the first module housing 122 into the inlet door of the second module housing 122.

In response to the food order specifying a first ingredient in a first region of the food container 115, the controller locates the first region of the food container 115 beneath a first food dispensing module 124 of the second module housing 122. The controller locates the first region of the food container 115 beneath the first food dispensing module 124 by: triggering a first conveyor belt 132 of the conveyor module 130 of the second module housing 122 to advance by a first distance 142; and triggering a second conveyor belt 134 of the conveyor module 130 of the second module housing 122 to advance by the first distance 142. For example, the controller can trigger the first and second conveyor belt to advance by 6 inches such that the food container 115 is advanced longitudinally by 6 inches. The controller then triggers the first food dispensing module 124 to dispense a first ingredient in the set of ingredients into the first region of the food container 115.

In response to the food order specifying a second ingredient in a second region of the food container 115, the controller: locates the second region of the food container 115 beneath a second food dispensing module 124 of the second module housing 122. The controller locates the second region of the food container 115 beneath a second food dispensing module 124 by: triggering the first conveyor belt 132 of the conveyor module 130 of the second module housing 122 to advance by a second distance 144; and triggering the second conveyor belt 134 of the conveyor module 130 of the second module housing 122 to advance by a third distance 146. For example, the controller can trigger the first conveyor belt 132 to advance by 4 inches and the second conveyor belt 134 to advance by 6 inches such that the food container 115 advances by 4 inches and rotates counterclockwise due to the additional 2 inches of movement of the second conveyor belt 134.

The controller then triggers the second food dispensing module 124 to dispense a second ingredient in the set of ingredients into the second region of the food container 115.

Once the controller triggers select food dispensing modules 124 in the series of module housings 122 to dispense ingredients specified in the food order into the food container 115, the controller: coordinates handoff from a last module housing 122 in the series to an elevator module 127; and triggers the elevator module 127 to raise the food container 115 to the food preparation zone. The controller: by the conveyor module 130 of the second module housing 122, transfers the food container 115 to an output door for the second module housing 122; by a conveyor module 130 of a third module housing 122 subsequent the second module housing 122, transfers the food container 115 from the output door of the second module housing 122 to the inlet door of the third module housing 122; and locates the food container 115 proximal an elevator module 127 of the third module housing 122. The controller locates the food container 115 proximal the elevator module 127 by: triggering a conveyor belt of the third conveyor module 130 to advance by a fourth distance; and triggering a second conveyor belt 134 of the third conveyor module 130 to advance the by a fifth distance. Then, the controller triggers the elevator module 127 to raise the food container 115 to a collection zone above the third module housing 122.

In one implementation, the controller can additionally receive plating instructions included in the food order. The plating instructions indicate a region of a food container 115 for an ingredient to be dispensed into. The controller triggers the conveyor module 130 to align a region of the food container 115 beneath a food dispensing module 124 according to the plating instructions.

In one example, the controller locates a third region of the food container 115 beneath a third food dispensing module 124 according to a plating instruction of the food order indicating a region within the food container 115 for each ingredient in the set of ingredients by: triggering the first conveyor belt 132 of the conveyor module 130 of the first module housing 122 to advance by a fourth distance; and triggering the second conveyor belt 134 of the conveyor module 130 of the first module housing 122 to advance by a fifth distance. For example, the controller can trigger the first conveyor belt 132 to advance 5 inches in a positive longitudinal direction (e.g., toward the elevator module 127) and trigger the second conveyor belt 134 to advance 5 inches in a negative longitudinal direction (e.g., toward the container dispenser) to rotate the food container 115 clockwise. The controller locates a fourth region of the food container 115 beneath a fourth food dispensing module 124 according to the actuation instruction by: triggering the first conveyor belt 132 of the conveyor module 130 of the first module housing 122 to advance by a sixth distance; and triggering the second conveyor belt 134 of the conveyor module 130 of the first module housing 122 to advance by a seventh distance. For example, the controller can undo the clockwise rotation caused by the fourth and fifth distances moved by the first and second conveyor belt. The controller can rotate the food container 115 counterclockwise to align the fourth region with the fourth food dispensing module 124 by advancing the first conveyor belt 132 5 inches in a negative longitudinal direction (e.g., toward the container dispensing module 125) and advancing the second conveyor belt 134 5 inches in a positive longitudinal direction (e.g., toward the container elevator).

### 8. Variation: Linear Conveyance+Plating

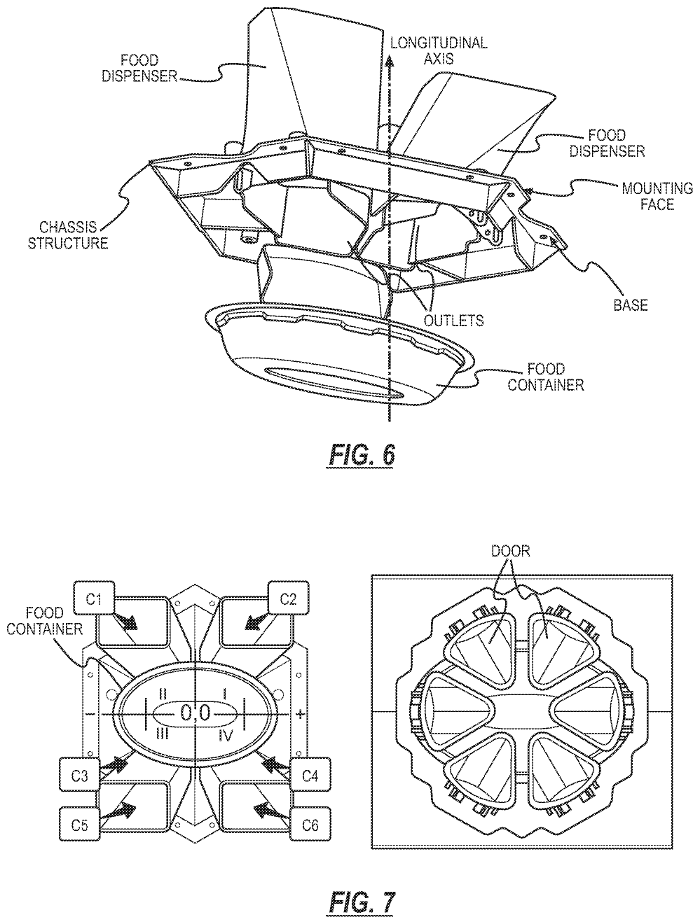

In one variation, as shown in FIGS. 4, 5, 6, and 7 the food production system 102 includes: the container dispensing module 125 configured to dispense containers onto a set of (e.g., two, three, five) conveyor belts of a conveyor module 130; the conveyor module 130 located adjacent the container dispensing module 125 and configured to transfer the container along a sequence of food dispensing modules 124 for dispensation of ingredients into the food container 115 according to a food order (e.g., submitted by a patron); and an elevator module 127 (or “food elevator”) located adjacent the conveyor module 130 and configured to receive the food container 115 from the conveyor module 130 and direct the food container 115—containing a set of ingredients matched to the food order and arranged in a target plating pattern (e.g., radial pattern, layered pattern)—toward the food preparation surface for collection by a worker and/or presentation to a patron.

In particular, in this variation, the container dispenser module can be configured to locate a base of the container on the set of conveyor belts in a target position (e.g., a central longitudinal segment of the base seated on a central conveyor belt in the set of conveyor belts). The conveyor module 130 can include a set of (e.g., two, four) conveyor belts configured to support the base of the food container 115 (e.g., a bowl) and operable at similar speeds in a linear motion (e.g., forward, backward) to: convey the food container 115 below each food dispensing module 124 along the food production system 102; and transiently locate the food container 115 in a target position (e.g., relative the food dispensing module 124) below a subset of food dispensing modules 124, in the set of food dispensing modules 124, according to the food order.

Each food dispensing module 124 can include: a set of (e.g., two, four, six) food chutes (or “food dispensers”) coupled to the set of hopper above the set of food chutes; a set of (e.g., two, four, six) dispenser doors coupled to the set of food chutes—opposite the set of hopper—and configured to transiently release ingredients from the set of food chutes into a container located on the conveyor module 130 below the food dispending module; a chassis structure configured to support the set of food chutes and the set of dispenser doors; and a set of motors (e.g., stepper and/or servo motors) coupled to the chassis structure and configured to transiently actuate the set of dispenser doors to release ingredients into the food container 115.

In one variation, the conveyor module 130 includes a set of (e.g., four) conveyor belts: laterally offset and mirrored across the longitudinal axis of the food production system 102; and cooperating to support opposing segments (e.g., longitudinal segments) of the base of the food container 115.

For example, the set of conveyor belts: can be configured such that each conveyor belt, in the set of conveyor belts, is laterally offset an adjacent conveyor belt by a target distance; can include a set of outer conveyor belts, in the set of conveyor belts, configured to be laterally offset by approximately the common width of a food container 115; are offset below the set of dispenser doors of the food dispensing module 124 by more than a maximum food container 115 height (e.g., 6.0″); and cooperate to support the underside of the base of each food container 115 at four narrow areas (or “segments”) on opposite sides of and/or across the base. Accordingly, the set of conveyor belts can accommodate food containers 115 of various depths, sizes, and/or lengths without necessitating a physical change to the food production system 102.

The controller is configured to: receive a set of food orders; coordinate motion of the conveyor module 13o; and selectively trigger each food dispensing module 124 to dispense amounts of ingredients into the set of food containers 115 to assemble units of the food product type according to the set of food orders. The controller can also track the position of the dispenser doors—and therefore food ingredients—during dispensation of the ingredients from a food dispenser to a food container 115 located on the set of conveyor belts within the conveyor module 130.

### 8.1 Applications

The conveyor module 130, within this variation of the food production system 102, includes a set of (e.g., two, four) conveyor belts configured to support the base of a food container 115 (e.g., a “bowl”) and operable at similar speeds in a linear motion (e.g., forward, backward) to convey the food container 115 under multiple food dispensing modules 124 within the food production system 102. In particular, the controller—within the food production system 102—can execute commands to operate the set of conveyor belts at similar speeds and directions in order to: convey the food container 115 over a range of positions along the food production system 102; sequentially locate target regions of the food container 115 under groups of food dispensing modules 124 within the food production system 102; concurrently or sequentially trigger these food dispensing modules 124 to dispense ingredients (e.g., hot ingredients, cold ingredients, dry ingredients) into the food container 115 to achieve a target (e.g., visually-appealing, visually-balanced, physically-balanced) ingredient plating—such as a radial-plating pattern or a spiral-plating pattern or a layered-plating pattern—defined for the food container 115; and thus achieve high food container 115 through-put and accurate and repeatable plating of custom combinations of ingredients.

Furthermore, the conveyor module 130 includes a set of conveyor belts configured to support and locate a base of a food container 115 and convey the food container 115 under a food dispensing module 124. By supporting the base of the food container 115, rather than the rim of the food container 115, the conveyor module 130 can: accept food containers 115 of various widths (and volumes; accept food containers 115 of various shapes (e.g., oval, round, rectangular); maintain the tops of these food containers 115 very near the outputs of the food dispensing modules 124—such as by locating the base of the food container 115 within a threshold distance (e.g., greater than a height of the food container 115) of these outputs; and maintain the base of the food containers 115 on the set of conveyor belts within a threshold distance (e.g., greater than one half of the height of the food container 115) above the base of the conveyor module 130—thereby limiting opportunity for ingredients to miss a target region of the food container 115 or fall out of the food container 115 during dispensation; reduce conveyance errors (e.g., jamming of the bowl) due to spillage of ingredients below the container and/or set of conveyor belts; and reduce balance errors of the food container 115, such as due to the food container 115 becoming imbalanced during dispensation of ingredients and tipping.

In particular, because the conveyor module 130 supports the base of the food container 115 uniformly and/or at mirrored segments across the base surface, the food container 115 may be substantially less susceptible to tipping. Therefore, the controller can execute commands to implement methods described above (and further below) to navigate the food container 115 between dispensing modules (e.g., arranged in adjacent module housings 122 within the food production system 102) in a linear, singular-direction motion to achieve the target ingredient plating, such as without requiring rotation of the food container 115 in order to maintain a weight balance of the food container 115.

Accordingly, the computer system can: define target regions (e.g., quadrants) within a coordinate system of the food container 115; and calculate a corresponding target location within a target region of the food container 115 for the food dispensing module 124 to dispense ingredients based on historical order frequency and known ingredient serving weights to yield the greatest central weight balance in the center of the food container 115 (e.g., via weight balance within each target region of the food container 115) and/or to yield greatest lateral weight balance parallel to the linear direction of motion of the conveyor module 130 at any time as the food production system 102 loads ingredients into the food container 115, and to fulfill predefined plating rules (e.g., lettuce or rice followed by toppings, then sauce, then condiments).

Therefore, the food production system 102 can enable greater food order throughput, greater order customization, greater food order accuracy, and both manual and automated food assembly within a single make line footprint. The food production system 102 also includes a conveyor module 130 configured to move food containers 115—of different volumes and/or shapes—in a linear motion (e.g., forward, backward) between food dispensing modules 124 in order to achieve visual- and weighted-balance of ingredients loaded into target regions of a food container 115.

### 8.2 Food Containers+Conveyor Belts

Generally, in this variation, the conveyor module 130 includes a set of (e.g., two, four, five) conveyor belts: laterally offset and mirrored across the longitudinal axis of the food production system 102, such that the base of the food container 115 is uniformly supported across a length and a width of the food container 115; and cooperating to support, longitudinal segments (e.g., parallel a direction of motion of the food container ns) of the base of a food container 115.

More specifically, in this variation, the food production system 102 is configured to store, load, and output food containers 115 (or “bowls”) of various shapes and sizes, such as an oval-shaped food container 115 (e.g., an elongated bowl), a rectangular-shaped food container 115, and/or any other shape of food container 115 exhibiting a nonuniform diameter.

In one variation, a first instance of the food production system 102 in a make line includes a cluster of container dispensing modules 125 configured to house food containers 115 of different lengths (e.g., within a target length range), widths (e.g., within a target width range), depths (e.g., within a target depth range), and/or shapes. The set of conveyor belts can include: a first conveyor belt 132; and a second conveyor belt 134 laterally offset the first conveyor belt 132 by approximately a maximum width of a base of a container, such that the first and second conveyor belt 134 support two narrow, opposing segments of the base of the food container 115. The set of conveyor belts can further include a subset of conveyor belts arranged between the first and second conveyor belt 134, such that each conveyor belt, in the set of conveyor belts, is laterally offset an adjacent conveyor belt by a set distance. Further, the set of conveyor belts are vertically offset output ports of the food dispensing modules 124 by more than a maximum food container 115 height. Accordingly, the set of conveyor belts can accommodate food containers 115 of various depths and maintain top edges of food containers 115 below output ports of the food dispensing modules 124 and thus avoid direct contact between containers and the food dispensing modules 124.

For example, the set of container dispensing modules 125 can include: a first container dispensing module 125 configured to dispense containers of a first size (e.g., small), an oval shape, and a first diameter (e.g., width and length), and a first depth; and a second container dispensing module 125 configured to dispense containers of a second size (e.g., medium), an oval shape, a width approximately equivalent the diameter of the first container, a length exceeding the diameter of the first container, and a second depth exceeding the first depth. However, because the set of conveyor belts are configured to receive a center of the base of the bowl at a central conveyor belt, in the set of conveyor belts, and are offset below the output ports of the food dispensing modules 124 by more than the second height (e.g., the maximum food container 115 height), the set of conveyor belts can receive and manipulate food containers 115 of both of these sizes.

Therefore, the food production system 102 can be configured to load, fill, and output food containers 115 characterized by a range of sizes and/or shapes and can locate these food containers 115 on the set of conveyor belts before reaching output ports of the food dispensing modules 124 without physical change or reconfiguration in the set of conveyor belts, the food dispensing modules 124, or container dispensing modules 125 within the food production system 102.

### 8.2.1 Cartridge Assembly

In one variation, the food production system 102 can be configured to receive a set of conveyor modules 130 for installation within the food production system 102. In particular, in this variation, the food production system 102 can be compatible with conveyor modules 130 of various conveyor types in order to accommodate different food container 115 sizes and shapes and different target plating configurations (e.g., target ingredient arrangements within the container).

In this variation, each module housing 122, in the sequence of module housings 122 of the food production system 102, can define a conveyor module 130 slot configured to transiently receive and locate a unit of the conveyor module 130 below a food dispensing module 124 arranged within the module housing 122. In particular, the conveyor module 130 slot can include a set of retention features configured to engage a corresponding set of engagement features arranged on the unit of conveyor module 130 to secure the conveyor module 130 within the module housing 122 and in a target orientation and position relative the food dispensing module 124.

For example, the set of conveyor modules 130 can include a first conveyor module 130 and a second conveyor module 130. The first conveyor module 130 can include a set of two conveyor belts: laterally offset and mirrored across the longitudinal axis of the food production system 102; cooperating to support short, opposing segments of a rim of a food container 115 of a uniform diameter; and operable at dissimilar speeds and directions to translate and rotate (e.g., in two degrees of freedom) the food container 115 under food dispensing modules 124 within the food production system 102. The second conveyor module 130 can include: a set of four conveyor belts: laterally offset and mirrored across the longitudinal axis of the food production system 102; cooperating to support narrow segments of a base of a food container 115 of a uniform and/or nonuniform diameter; and operable at uniform speeds and directions to translate the food container 115 under food dispensing modules 124 within the food production system 102. In this example, the food production system 102 can be configured to: during a first time period, receive and locate the first conveyor module 130 within the food production system 102—via coupling in the set of retention features, of the conveyor module 130 slot, to a first set of engagement features on the conveyor module 130—to dispense ingredients into round food bowls (e.g., of a uniform diameter) of various depths and volumes according to a target plating pattern; and, during a second time period, receive and locate the second conveyor module 130, in replacement of the first conveyor module 130 within the food production system 102—via coupling in the set of retention features to a second set of engagement features on the second conveyor module 130—to dispense ingredients into non-round food bowls (e.g., oval, rectangular) of various lengths or shapes according to a target plating pattern.

Additionally, the food production system 102 can be configured to enable: locating and removal of the unit of the conveyor module 130 (e.g., by a user) within the food production system 102—such as via uncoupling in the set of retention features, of the conveyor module 130 slot, to the corresponding set of engagement features on the conveyor module 130—thereby enabling the unit of the conveyor module 130 to be serviced and cleaned (e.g., in a sink or in a dishwasher) for removal of spilled food ingredients from the conveyor module 130 and/or for replacement with a different conveyor module 130. Further, in one implementation, to enable rapid installation and removal of units of the conveyor module 130 from the food production system 102 for cleaning, the food production system 102 can include a set of fixed conveyor infrastructure units permanently and/or semi-permanently installed within the food production system 102. For example, the set of fixed conveyor infrastructure units can include a set of motors and/or electronics configured to drive and/or control actuation of an installed unit of the conveyor module 130. In this implementation, the conveyor unit—including the set of conveyor belts—can therefore be rapidly installed and/or removed from the food production system 102 for cleaning, without requiring removal or reinstallation of these fixed conveyor infrastructure units within the food production system 102.

### 8.3 Food Dispensing Module

As described above, the food production system 102 includes a sequence of food dispensing modules 124, each food dispensing module 124 (e.g., automatic dispenser) configured to: transiently install on the autonomous assembly zone 120 proximal the conveyor; and dispense metered amounts (e.g., a volume, a mass, a number of units) of an ingredient—such as metered amounts of a liquid, solid, hot, and/or cold ingredient—toward the conveyor (e.g., into a food container 115 on the conveyor). Each food dispensing module 124 can be removed from the food production system 102 for cleaning and/or reloading with ingredients for assembling food orders. For example, a worker may rapidly and easily remove (e.g., without any tools) a food dispensing module 124 from the food production system 102 for cleaning, reload the food dispensing module 124 with a particular ingredient, and replace the food dispensing module 124 within the food production system 102.

Generally, each food dispensing module 124: defines a longitudinal axis between the food preparation surface and a base of the food production system 102; a set of (e.g., two, four, six) food chutes (or “food dispensers”), each food chute coupled to a food hopper 114 and configured to selectively dispense units of a food ingredient—contained in the food hopper 114—according to food orders received from patrons; a set of (e.g., two, four, six) dispenser doors, each door pivotably coupled to an output of a corresponding food chute and configured to selectively transition between a “closed” position and an “open” position to release ingredients from the food chute into a container arranged below the food dispensing module 124 (e.g., supported by the set of conveyor belts); a chassis structure configured to support the set of food chutes—and the set of dispenser doors coupled to the set of food chutes—in a target configuration matched to a target ingredient plating; and a set of stepper or servo motors coupled to the chassis structure and configured to drive the set of dispenser doors between the “closed” and “open” positions—responsive to a command from the controller—to release ingredients from the set of food chutes (hereinafter “food dispensers”) and into the food container 115 via actuation in the set of dispenser doors. The controller can thus trigger the set of conveyor belts to locate a food container 115 in a target position—such as centered below the chassis structure and/or in a particular position relative one or more dispenser doors in the set of dispenser doors—below a food dispensing module 124. The set of food dispensers, the chassis structure, and the set of dispenser doors cooperate to transiently transfer food ingredients from a set of food hopper—arranged above and coupled to the set of food dispensers—into a food container 115 located below the set of food dispensers, on the set of conveyor belts, and in the target position. In one example, each food dispenser or “chute” can include a load cell configured to detect an amount of an ingredient loaded in the dispenser. In this example, based on a food order, the controller can trigger a first hopper 114—coupled to a first food dispenser—to release an amount of a particular ingredient into the first food dispenser. The controller can thus access the measured amount of the particular ingredient loaded in the first food dispenser in order to enable loading of a target amount of the ingredient into the dispenser in preparation for release into the container. Then, in response to the conveyor module 130 locating the container in a target container position and/or orientation below the food dispensing module 124, the controller can trigger the set of motors to drive a dispenser door—coupled to the first food dispenser—into the open position to release the target amount of the ingredient into the container at a target location within the container.

Furthermore, the controller can trigger the set of stepper or servo motors to open the set of dispenser doors and then track the position of the dispenser doors—and therefore food ingredients—during dispensation of the ingredients from a food dispenser to a food container 115 located on the set of conveyor belts within the conveyor module 130 based on positions of the stepper or servo motors.

### 8.3.1 Food Dispensers

The set of food dispensers are configured to transiently transfer food ingredients from a food hopper 114 located above each food dispenser to a food container 115 located below the set of food dispensers on the set of conveyor belts.

In one implementation, the set of food dispensers are arranged in a pattern along the circumference of a chassis structure. Each food dispenser in the set of food dispensers defines an angular offset within a target angular offset range (e.g., 3o degrees to 6o degrees) relative the longitudinal axis of the food dispensing module 124 to accurately and repeatably dispense food ingredients into a particular target region of the food container 115.

Furthermore, each food dispenser, in the set of food dispensers, is removably coupled to a chassis structure and configured to combine with another food dispenser: to transiently transfer a particular food ingredient (e.g., lettuce, rice, salsa); and to achieve accurate plating into the food container 115. Therefore, the set of food dispensers enables an installer/employee to remove and install a food dispenser for a particular ingredient of a food order into the food container 115 to achieve a target (e.g., visually-appealing, visually-balanced, physically-balanced) ingredient plating for the food container 115; and thus achieve high food container 115 through-put and accurate and repeatable plating of custom combinations of ingredients.

In one variation, the food dispenser can be configured to dispense volumetric units of “fluid” food ingredients, such as dressings, pastes, liquids, etc. For example, a liquid food dispensing module 124 can include a pump configured to dispense metered volumes of “fluid” food ingredients directly into the food container 115. The conveyor module 130 can therefore be configured to similarly locate a food container 115 proximal an output of the pump for accurate dispensation of a “fluid” food ingredient into a target region within the food container 115.

However, the food dispenser can additionally or alternatively implement methods and techniques described above to directly dispense food ingredients (e.g., chicken, rice, lettuce, beans, corn, cheese) and/or “fluid” food ingredients (e.g., dressings, liquids, pastes) into target regions of the food container 115 located on the set of conveyor belts within the conveyor module 130 in any other way.

### 8.3.2 Chassis Structure+Stepper Motors

The chassis structure is arranged between the set of food dispensers and the set of dispenser doors within the food dispensing module 124. The chassis structure includes a mounting face; a base opposite the mounting face; and a set of outputs extending between the mounting face and the base.

In one implementation, the chassis structure includes a mounting face removably coupled to the set of food dispensers, a base opposite the mounting face and pivotably coupled to the set of dispenser doors, and a set of outputs extending between the mounting face and the base configured to house the set of dispenser doors in a closed position. Each output in the set of outputs defines a first size and is configured to interface with each door to retain and dispense food between a food dispenser and the food container 115.

The set of stepper or servo motors are mounted to the chassis structure and configured to drive a set of dispenser doors of the food dispensing module 124 from a closed position (e.g., retaining food ingredients) to an open position (e.g., dispensing food ingredients) to dispense food ingredients into target regions of the food container 115.

### 8.3.3 Dispenser Doors

The set of dispenser doors (e.g., flaps, hatches, levers) are pivotably coupled to the base of the chassis structure and are operable—via the set of stepper motors—within a swing angle from a closed position (e.g., retaining food ingredients) to an open position (e.g., dispensing food ingredients) into target regions of the food container 115.

In one implementation, each door, in the set of dispenser doors, extends radially from the longitudinal axis of the food dispensing module 124 and exhibits a triangular cross-section with a set of (e.g., two) vertices pivotably coupled to the base face of the chassis structure. Each door, in the set of dispenser doors, defines a second size less than the first size of each output in the set of outputs of the chassis structure and thus can cooperate with the set of outputs in a closed position to retain food ingredients. In this implementation, the set of dispenser doors are operable within a target swing angle range—such as 45 degrees to 90 degrees relative the base of the chassis structure—between the closed position and the open position to accurately dispense food ingredients into target regions of the food container 115 and to reduce food ingredient spillage during dispensation.

However, the set of dispenser doors can define any other cross-section arrangement within the set of outputs of the chassis structure and/or define any other size less than the size in the set of outputs.

### 8.3.4 Example Configuration: Quadrilateral Chassis Structure

In one example configuration, the food dispensing module 124 includes a set of (e.g., four) food dispensers, a set of (e.g., four) dispenser doors, a set of (e.g., four) outputs to define a quadrilateral chassis structure. In particular, a subset of (e.g., two) food dispensers, a subset of (e.g., two) dispenser doors, and a subset of (e.g., two) outputs are arranged on each side of the longitudinal axis of the food dispensing module 124 and cooperate to retain and dispense food ingredients into a food container 115 located on the set of conveyor belts.

In this example, the food production system 102 is configured to fulfill a patron's order for a Burrito Bowl. Accordingly, the food production system 102 can include: a first food dispensing module 124—exhibiting the example configuration—arranged in a first stage in the autonomous assembly zone 120, along the longitudinal axis of the food production system 102 (e.g., opposite of an employee working at the food production system 102); and a second food dispensing module 124—exhibiting the example configuration—arranged in a second stage in the autonomous assembly zone 120 adjacent the first stage. Then, responsive to entry of a first food container 115 onto the set of conveyor belts in the conveyor module 130, the controller can: receive an image from an optical sensor defining a field of view intersecting the conveyor module 13o; identify the first food container 115 within the image; access a first list of menu items labeled with recipes of ingredients; extract a first menu item of the Burrito Bowl associated with the first food container 115; scan the food production system 102 for food dispensing modules 124 that contain ingredients according to the recipe for the Burrito Bowl; and activate pre-feeding of base ingredients and intermediate ingredients at each food dispensing module 124.

At approximately a first time, the controller can: actuate the set of conveyor belts to move the first food container 115 into a first position in the first stage; and actuate a first stepper motor to open a first dispenser door within a first food dispensing module 124 to dispense a first base ingredient (e.g., a scoop of rice) with a large mass (e.g., greater than a predefined ingredient mass threshold) from a first food dispenser to the food container 115. At approximately a second time, the controller can actuate a second stepper motor to open a second dispenser door to dispense a first intermediate ingredient (e.g., a hot ingredient such as steak) from a second food dispenser to the food container 115 according to the recipe for the Burrito Bowl. At approximately a third time, the controller can actuate a third stepper motor to open a third dispenser door within the food dispensing module 124 to dispense a second intermediate ingredient (e.g., a hot ingredient such as beans) from a third food dispenser to the food container 115. At approximately a fourth time, the controller can actuate a fourth stepper motor to open a fourth dispenser door to dispense a third intermediate ingredient (e.g., a hot ingredient such as corn) from a fourth food dispenser to the food container 115. Then, the controller can actuate the first, second, third, and fourth stepper motors to close the first, second, third, and fourth dispenser doors.

At approximately a fourth time, the controller can: actuate the set of conveyor belts to move the food container 115 forward (e.g., toward the food elevator) to a second position in the first stage below a second food dispensing module 124; and actuate a fifth stepper motor to open a fifth dispenser door to dispense a fourth intermediate ingredient (e.g., a cold ingredient such as cheese) from a second food dispensing module 124 to the food container 115. At approximately a sixth time, the controller can actuate a sixth stepper motor to open a sixth dispenser door to dispense a topping ingredient (e.g., a cold ingredient such as salsa) from a sixth food dispenser to complete the food order according to the recipe for the Burrito Bowl. The controller can then actuate the fifth and sixth stepper motors to close the fifth and sixth dispenser doors.

Therefore, the controller can: actuate the set of conveyor belts to move the food container 115 in a linear motion (e.g., forward, backward) between the first food dispensing module 124 and the second food dispensing module 124; and actuate stepper motors to open dispenser doors to dispense ingredients from food dispensers within both food dispensing modules 124 in order to assemble food orders with a particular series of ingredient dispensation such that a base ingredient is dispensed first into the food container 115, followed by intermediate ingredients, and then followed by toppings and/or liquids.

### 8.3.5 Example: Hexagonal Chassis Structure

In one example configuration, the food dispensing module 124 includes a set of (e.g., six) food dispensers, a set of (e.g., six) dispenser doors and a set of (e.g., six) outputs to define a hexagonal chassis structure. In particular, a subset of (e.g., three) food dispensers, a subset of (e.g., three) dispenser doors, and a subset of (e.g., three) outputs are arranged on each side of the longitudinal axis of the food dispensing module 124 and cooperate to retain and dispense food ingredients into a food container 115 located on the first and second conveyor belt.

In this example, the food production system 102 is configured to fulfill a patron's order for a Burrito Bowl. The food production system 102 can include one food dispensing module 124—exhibiting the example configuration—arranged in a first stage in the autonomous assembly zone 120, along the longitudinal axis of the food production system 102 (e.g., opposite an employee working at the food production system 102). Then, responsive to entry of a first food container 115 onto the first and second conveyor belt in the conveyor module 130, the controller can: receive an image from an optical sensor defining a field of view intersecting the conveyor module iso; identify the first food container 115 within the image; access a first list of menu items labeled with recipes of ingredients; extract a first menu item of the Burrito Bowl associated with the first food container 115; scan the food production system 102 for food dispensing modules 124 that contain ingredients according to the recipe for the Burrito Bowl; and activate pre-feeding of base ingredients and intermediate ingredients at each food dispensing module 124.

At approximately a first time, the controller can actuate: the first and second conveyor belt to move the first food container 115 into a first position in the first stage; and a first stepper motor to open a first dispenser door and a second stepper motor to open a second dispenser door within the food dispensing module 124 to dispense a first base ingredient (e.g., a bed of greens) with a large mass (e.g., greater than a predefined ingredient mass threshold) from a first food dispenser and a second food dispenser to the food container 115. At approximately a second time, the controller can actuate a third stepper motor to open a third dispenser door to dispense a first intermediate ingredient (e.g., a hot ingredient such as chicken) from a third food dispenser to the food container 115 according to the recipe for the Burrito Bowl. At approximately a third time, the controller can actuate a fourth stepper motor to open a fourth dispenser door within the food dispensing module 124 to dispense a second intermediate ingredient (e.g., a hot ingredient such as corn) from a fourth food dispenser to the food container 115. At approximately a fourth time, the controller can actuate a fifth stepper motor to open a fifth dispenser door to dispense a third intermediate ingredient (e.g., a cold ingredient such as cheese) from a fifth food dispenser to the food container 115. Then, the controller can actuate a sixth stepper motor to open a sixth dispenser door to dispense a topping ingredient (e.g., a cold ingredient such as guacamole) from a sixth food dispenser to complete the food order according to the recipe for the Burrito Bowl. The controller can then actuate the first, second, third, fourth, fifth, and sixth stepper motors to close the first, second, third, fourth, fifth, and sixth dispenser doors.

Therefore, the controller can actuate the set of (e.g., six) stepper motors to open the set of (e.g., six) dispenser doors to dispense ingredients from the set of (e.g., six) food dispensers within the food dispensing module 124 in order to assemble food orders with a particular series of ingredient dispensation such that a base ingredient is dispensed first into the food container 115, followed by intermediate ingredients, and then followed by toppings and/or liquids. The target locations and particular series of ingredient dispensation maintain a balanced weight of ingredients in the food container 115 after each ingredient is dispensed from the food dispensing module 124.

However, the controller can additionally or alternatively implement methods and techniques described above to complete food orders with any other configuration of food dispensing modules 124 and/or with any other example configuration and can interface with food dispensing modules 124, processing modules, and the first and second conveyor belt in any other way.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

As a person skilled in the art will recognize from the previous detailed description and from the FIGS. and claims, modifications and changes can be made to the embodiments of the invention without departing from the scope of this invention as defined in the following claims.

I claim:

1. A food production system comprising:
a food preparation surface at work surface height defining a receptacle configured to receive a of food hopper configured to store ingredients for preparation of units of a food product type;
a first module housing:
supporting the food preparation surface;
defining an autonomous assembly zone extending along a longitudinal assembly axis;
configured to transiently house a first food dispensing module located below the food preparation surface and configured to dispense a first ingredient toward the autonomous assembly zone; and
configured to transiently house a second food dispensing module located below the food preparation surface, located adjacent the first food dispensing module, and configured to dispense a second ingredient toward the autonomous assembly zone;
comprising a first conveyor module:
arranged within the autonomous assembly zone of the first module housing;
comprising a first conveyor belt extending parallel to and laterally offset behind the longitudinal assembly axis;
comprising a second conveyor belt:
extending parallel to and laterally offset in front of the longitudinal assembly axis; and
configured to cooperate with the first conveyor belt to support a rim of a food container with a base of the food container extending below the first conveyor belt and the second conveyor belt; and
a controller configured to:
receive a food order indicating a first ingredient and a second ingredient;
locate a first region of the food container beneath the first food dispensing module by triggering the first conveyor belt and the second conveyor belt to advance by a first distance;
trigger the first food dispensing module to dispense the first ingredient into the first region of the food container;
locate a second region of the food container beneath the second food dispensing module by:
triggering the first conveyor belt to advance by a second distance; and
triggering the second conveyor belt to advance by a third distance; and
trigger the second food dispensing module to dispense the second ingredient into the second region of the food container.

2. The food production system of claim [0019]:
wherein the first module housing comprises:
a first inlet door facing the container dispensing module;
further comprising a container dispensing module:
arranged adjacent the first conveyor module; and
configured to dispense the food container into the first inlet door of the first conveyor module; and
wherein the controller is further configured to:
trigger the first conveyor belt and the second conveyor belt to advance by the first distance to:
load the food container from the container dispensing module onto the first conveyor and the second conveyor via the first inlet door; and
transition the food container from the first inlet door to a first position under the first food dispensing module.

3. The system of claim 2:
wherein the first module housing comprises:
a first output door facing a second module housing containing a third food dispensing module, the first conveyor module interposed between the first inlet door and the first output door; and
wherein the controller is further configured to:
transition the food container out of the first module housing and into the second module housing by triggering the first conveyor belt and the second conveyor belt to advance by a fourth distance.

4. The system of claim 3:
further comprising the second module housing:
supporting the food preparation surface;
defining a second autonomous assembly zone extending along the longitudinal assembly axis;
configured to transiently house the third food dispensing module located below the food preparation surface and configured to dispense a third ingredient toward the autonomous assembly zone; and
comprising a second inlet door;
comprising a second output door;
comprising a second conveyor module:
interposed between the second inlet door and the second output door;
arranged within the second autonomous assembly zone of the second module housing;
comprising a third conveyor belt extending parallel to and laterally offset behind the longitudinal assembly axis;
comprising a fourth conveyor belt:
extending parallel to and laterally offset in front of the longitudinal assembly axis; and
configured to cooperate with the third conveyor belt to support the rim of the food container with the base of the food container extending below the third conveyor belt and the fourth conveyor belt; and
wherein the controller is further configured to:
trigger the third conveyor belt and the fourth conveyor belt to advance by the fifth distance to:
load the food container from the first module housing onto the third conveyor and the fourth conveyor via the second inlet door; and
transition the food container from the second inlet door to a third position under the third food dispensing module.
locate a third region of the food container beneath the third food dispensing module;
trigger the third food dispensing module to dispense the third ingredient into the third region of the food container;

5. The system of claim 4, further comprising an elevator module:
downstream of the second module housing;
defining a third inlet door configured to receive the food container downstream of the first module housing and the second module housing; and
configured to raise the food container to the food preparation surface for collection by an operator.

6. The food production system of claim [0019]:
wherein first conveyor belt is configured to contact and support a first arc of the food container, the first arc defining a first arc length less than 5% of a circumference of the food container; and
wherein second conveyor belt is configured to contact and support a second arc of the food container, the second arc opposite the first arc and defining a second arc length less than 5% of the circumference of the food container.

7. The food production system of claim [0019]:
wherein the first food dispensing module is laterally centered over the longitudinal assembly axis;
wherein the second food dispensing module is laterally centered over the longitudinal assembly axis and is laterally offset from the first food dispensing module; and
wherein the controller is configured to:
advance the food container to locate the first region of the food container centered beneath the first food dispensing module, laterally centered along the longitudinal assembly axis, and located between the first conveyor belt and the second conveyor belt by triggering the first conveyor belt and the second conveyor belt to advance by the first distance;
advance and rotate the food container to locate the second region of the food container centered beneath the second food dispensing module, laterally centered along the longitudinal assembly axis, and located between the first conveyor belt and the second conveyor belt by:
triggering the first conveyor belt to advance by the second distance; and
triggering the second conveyor belt to advance by the third distance different from the second distance.

8. The food production system of claim [0019]:
wherein the first food dispensing module is longitudinally offset from over the longitudinal assembly axis and biased toward the second conveyor belt;
wherein the second food dispensing module is longitudinally offset from over the longitudinal assembly axis, is biased toward the second conveyor belt, and is laterally offset from the first food dispensing module; and
wherein the controller is configured to:
advance the food container to locate the first region of the food container centered beneath the first food dispensing module, longitudinally offset from the longitudinal assembly axis, and located adjacent the second conveyor belt by triggering the first conveyor belt and the second conveyor belt to advance by the first distance;
advance and rotate the food container to locate the second region of the food container centered beneath the second food dispensing module, longitudinally offset from the longitudinal assembly axis, and located adjacent the second conveyor belt by:
triggering the first conveyor belt to advance by the second distance; and
triggering the second conveyor belt to advance by the third distance different from the second distance.

9. The food production system of claim [0019]:
wherein the first food dispensing module and the second food dispensing module are arranged in a radial pattern over the autonomous assembly zone;
wherein the controller is configured to:
advance the food container to locate the first region of the food container centered beneath the first food dispensing module by triggering the first conveyor belt and the second conveyor belt to advance in a first longitudinal direction by the first distance;
rotate the food container to locate the second region of the food container centered beneath the second food dispensing module by:
triggering the first conveyor belt to advance in the first longitudinal direction by the second distance; and
triggering the second conveyor belt to advance in a second longitudinal direction opposite the first longitudinal direction by the third distance equal to the second distance.

10. The food production system of claim [0019]:
wherein the controller is configured to:
advance the food container to locate the first region of the food container centered beneath the first food dispensing module by triggering the first conveyor belt and the second conveyor belt to advance in a first longitudinal direction by the first distance;
trigger the first food dispensing module to dispense a first portion of a target mass of the first ingredient into the first region of the food container;
rotate the food container to locate a third region of the food container, opposite the first region, centered beneath the first food dispensing module by:
triggering the first conveyor belt to advance in the first longitudinal direction by a fourth distance; and
triggering the second conveyor belt to advance in a second longitudinal direction opposite the first longitudinal direction by the fourth distance; and
trigger the first food dispensing module to dispense a second portion of the target mass of the first ingredient into the third region of the food container.

11. The food production system of claim [0019], further comprising:
a first rail arranged under the first conveyor belt and configured to rigidly support a first section of the first conveyor belt in contact with the rim of the food container; and
a second rail arranged under the second conveyor belt and configured to rigidly support a second section of the second conveyor belt in contact with the rim of the food container.

12. The food production system of claim 11:
further comprising:
a first weight sensor coupled to the first rail and configured to output a first signal corresponding to a first weight of the food container carried by the first conveyor belt; and
a second weight sensor coupled to the second rail and configured to output a second signal corresponding to a second weight of the food container carried by the second conveyor belt; and
wherein the controller is configured to:
receive the first signal from the first weight sensor;
receive the second signal from the second weight sensor;
calculate a lateral center of mass of the food container based on the first signal and the second signal; and
define the second region of the food container corresponding to a greatest distance, within the food container, from the lateral center of mass of the food container.

13. The food production system of claim 11:
further comprising:
a first weight sensor coupled to the first rail and configured to output a first signal corresponding to a first weight of the food container carried by the first conveyor belt; and
a second weight sensor coupled to the second rail and configured to output a second signal corresponding to a second weight of the food container carried by the second conveyor belt; and
wherein the controller is configured to:
receive the first signal from the first weight sensor;
receive the second signal from the second weight sensor;
calculate a first lateral center of mass of the food container based on the first signal and the second signal;
rotate the food container ninety degrees:
triggering the first conveyor belt to advance in a first longitudinal direction by a fourth distance; and
triggering the second conveyor belt to advance in a second longitudinal direction opposite the first longitudinal direction by the fourth distance; and
calculate a second lateral center of mass of the food container based on the first signal and the second signal;
calculate a two-dimensional center of mass of the food container based on the first lateral center of mass and the second lateral center of mass; and
define the second region of the food container corresponding to a greatest distance, within the food container, from the lateral center of mass of the food container.

14. The food production system of claim [0019]:
wherein the food order further comprises a plating instruction indicating a region within the food container for each ingredient in the set of ingredients; and
wherein the controller is further configured to align a region of the food container beneath a food dispensing module according to the plating instructions.

15. The food production system of claim [0019], wherein the first conveyor module is further configured to:
support the rim of a first food container of a first depth at a target distance beneath the food dispensing module; and
support the rim of a second food container of a second depth at the target distance beneath the food dispensing module, wherein the second depth is greater than the first depth and a base of the second food container is suspended closer to a bottom of the module housing than a base of the first food container.

16. A method for preparation of a unit of a food product type comprising:
receiving a food order indicating a set of ingredients to be dispensed into a set of regions of a food container comprising the unit of the food product type;
in response to the food order specifying a first ingredient in a first region of the food container:
locating the first region of the food container beneath a first food dispensing module of a first module housing by:
triggering a first conveyor belt of the conveyor module of the first module housing to advance by a first distance; and
triggering a second conveyor belt of the conveyor module of the first module housing to advance by the first distance;
triggering the first food dispensing module to dispense a first ingredient in the set of ingredients into the first region of the food container;
in response to the food order specifying a second ingredient in a second region of the food container:
locating the second region of the food container beneath a second food dispensing module of the first module housing by:
triggering the first conveyor belt of the conveyor module of the first module housing to advance by a second distance; and
triggering the second conveyor belt of the conveyor module of the first module housing to advance by a third distance; and
triggering the second food dispensing module to dispense a second ingredient in the set of ingredients into the second region of the food container.

17. The method of claim 16, further comprising:
triggering a container dispensing module to dispense a food container onto a conveyor module of a second module housing preceding the first module housing;
by the conveyor module of the second module housing, transferring the food container to an output door of the second module housing abutting an inlet door of the first module housing;
by the conveyor module of the first module housing, transferring the food container from the output door of the second module housing into the inlet door of the first module housing;
transferring, by the conveyor module of the first module housing, the food container to an output door of the first module housing;
transferring, by a conveyor module of a third module housing subsequent the first module housing, the food container from the output door of the first module housing to an inlet door of the third module housing;
locating the food container proximal an elevator module of the third module housing by:
triggering a conveyor belt of the third conveyor module to advance by a fourth distance; and
triggering a second conveyor belt of the third conveyor module to advance the by a fifth distance; and
triggering the elevator module to raise the food container to a collection zone above the third module housing.

18. The method of claim 16, further comprising:
locating a third region of the food container beneath a third food dispensing module according to a plating instruction of the food order indicating a region within the food container for each ingredient in the set of ingredients by:
triggering the first conveyor belt of the conveyor module of the first module housing to advance by a fourth distance; and
triggering the second conveyor belt of the conveyor module of the first module housing to advance by a fifth distance; and
locating a fourth region of the food container beneath a fourth food dispensing module according to the actuation instruction by:
triggering the first conveyor belt of the conveyor module of the first module housing to advance by a sixth distance; and
triggering the second conveyor belt of the conveyor module of the first module housing to advance by a seventh distance.

19. The method of claim 16, further comprising:
receiving a first signal from a first weight sensor coupled to a first rail supporting the first conveyor belt and configured to output a first signal corresponding to a first weight of the food container carried by the first conveyor belt;
receiving a second signal from the second weight sensor coupled to the second rail and configured to output a second signal corresponding to a second weight of the food container carried by the second conveyor belt;
calculating a first lateral center of mass of the food container based on the first signal and the second signal;
rotating the food container ninety degrees:
triggering the first conveyor belt to advance in a first longitudinal direction by a fourth distance; and
triggering the second conveyor belt to advance in a second longitudinal direction opposite the first longitudinal direction by the fourth distance; and
calculating a second lateral center of mass of the food container based on the first signal and the second signal;
calculating a two-dimensional center of mass of the food container based on the first lateral center of mass and the second lateral center of mass; and
defining the second region of the food container corresponding to a greatest distance, within the food container, from the lateral center of mass of the food container.

20. A food production system comprising:
a first module housing:
defining an autonomous assembly zone extending along a longitudinal assembly axis;
configured to transiently house a first food dispensing module configured to dispense a first ingredient toward the autonomous assembly zone; and
configured to transiently house a second food dispensing module located adjacent the first food dispensing module, and configured to dispense a second ingredient toward the autonomous assembly zone;
comprising a first conveyor module:
arranged within the autonomous assembly zone of the first module housing;
comprising a first conveyor belt extending parallel to and longitudinally offset behind the longitudinal assembly axis;
comprising a second conveyor belt:
extending parallel to and longitudinally offset in front of the longitudinal assembly axis; and
configured to cooperate with the first conveyor belt to support a rim of a food container with a base of the food container extending below the first conveyor belt and the second conveyor belt; and
a controller configured to:
receive a food order indicating a first ingredient and a second ingredient;
locate a first region of the food container beneath the first food dispensing module by triggering the first conveyor belt and the second conveyor belt to advance by a first distance;
trigger the first food dispensing module to dispense the first ingredient into the first region of the food container;
locate a second region of the food container beneath the second food dispensing module by:
triggering the first conveyor belt to advance by a second distance; and
triggering the second conveyor belt to advance by a third distance; and
trigger the second food dispensing module to dispense the second ingredient into the second region of the food container.
